(19) United States
(12) Patent Application Publication
(10) Pub. No.: US 2026/0149846 A1
(43) Pub. Date: May 28, 2026

(54) METHOD PERFORMED BY ELECTRONIC APPARATUS, ELECTRONIC APPARATUS AND STORAGE MEDIUM

(71) Applicant: Samsung Electronics Co., Ltd., Suwon-si (KR)

(72) Inventors: Wei LIU, Beijing (CN); Lei YANG, Beijing (CN)

(21) Appl. No.: 19/413,475

(22) Filed: Dec. 9, 2025

Related U.S. Application Data
(63) Continuation of application No. PCT/IB2025/060839, filed on Oct. 24, 2025.

(30) Foreign Application Priority Data
Nov. 22, 2024 (CN) 202411687789.2

(51) Int. Cl. H04N 21/439; G06T 7/20; G06T 7/50; H04N 21/81

(52) U.S. Cl. CPC H04N 21/4394; G06T 7/20; G06T 7/50; H04N 21/8106

(57) ABSTRACT

A method performed by an electronic apparatus, an electronic apparatus and a storage medium, which involves the field of artificial intelligence are provided. The method includes obtaining target sound masks of a target in a first video at respective moments, based on image-related information of the target, a first audio signal corresponding to the first video, and direction information of the first audio signal, and obtaining a second audio signal in which a sound related to the target is excluded, based on the target sound masks of the target at the respective moments and the first audio signal.

### CROSS-REFERENCE TO RELATED APPLICATION(S)

This application is a continuation application, claiming priority under 35 U.S.C. § 365(c), of an International application No. PCT/IB 2025/060839, filed on Oct. 24, 2025, which is based on and claims the benefit of a Chinese patent application number 202411687789.2, filed on Nov. 22, 2024, in the Chinese Intellectual Property Office, the disclosure of which is incorporated by reference herein in its entirety.

### BACKGROUND

### 1. Field

The disclosure relates to a field of a signal processing technology. More particularly, the disclosure relates to a method for processing an audio signal performed by an electronic apparatus, an electronic apparatus and a storage medium.

### 2. Description of Related Art

Currently, a video inpainting operation may fill a damaged target area in a video (e.g., using content that is likely to be present, like an image that is consistent with a background), and may also remove a selected area or a target object and then fill the same using content that is consistent both temporally and spatially. However, during the video inpainting operation, an audio corresponding to the video is usually not processed, and no elimination of a sound related to the removed target is performed, this is because the sound related to the target cannot be directly determined, meanwhile the target may move or be obstructed, which likewise increases a difficulty of eliminating or extracting the sound related to the target.

How to accurately eliminate or extract the sound related to the target from the audio related to the video during the video inpainting operation to satisfy a user demand is a technical problem that those skilled in the art have been working on.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method performed by an electronic apparatus, an electronic apparatus and a storage medium.

Additional aspects will be set forth in part in the description which follows and, in part, will be apparent from the description, or may be learned by practice of the presented embodiments.

In accordance with an aspect of the disclosure, a method performed by an electronic apparatus is provided. The method includes obtaining target sound masks of a target in a first video at respective moments, based on image-related information of the target, a first audio signal corresponding to the first video, and direction information of the first audio signal, and obtaining a second audio signal in which a sound related to the target is excluded, based on the target sound masks of the target at the respective moments and the first audio signal.

Alternatively, the image-related information includes a target vision mask, depth information and optical flow information of the target.

Alternatively, the obtaining of the target sound masks of the target in the first video at the respective moments, based on the image-related information of the target, the first audio signal corresponding to the first video, and the direction information of the first audio signal, includes obtaining a first mask for each audio frame of the first audio signal, based on the image-related information and the direction information, and obtaining the target sound mask of the target at each audio frame of the first audio signal, based on the first mask for each audio frame and encoded features of the first audio signal.

Alternatively, the obtaining of the first mask for each audio frame of the first audio signal, based on the image-related information and the direction information, includes obtaining a sound signal spatial distribution feature for each audio frame, by normalizing and encoding the direction information, obtaining a target spatial distribution feature for each audio frame, by encoding a target vision mask and depth information of the target in the image-related information, obtaining a first feature for each audio frame, based on the sound signal spatial distribution feature and the target spatial distribution feature, obtaining the first mask for each audio frame, based on the first feature and optical flow information of the target in the image-related information.

Alternatively, the obtaining of the first feature for each audio frame, based on the sound signal spatial distribution feature and the target spatial distribution feature, includes obtaining the first feature for each audio frame, by performing a feature processing on the sound signal spatial distribution feature and the target spatial distribution feature, wherein the first feature represents a position of the target in a space, and a direction of a sound contained in the target vision mask.

Alternatively, the obtaining of the first mask for each audio frame, based on the first feature and the optical flow information of the target in the image-related information, includes determining a spatial motion trend of the target for each audio frame, based on the first feature and the optical flow information, determining a sound source motion trend within the target vision mask for each audio frame, based on the first feature, obtaining the first mask for each audio frame, based on a determination result of the spatial motion trend and a determination result of the sound source motion trend.

Alternatively, the determining of the spatial motion trend of the target for each audio frame, based on the first feature and the optical flow information, includes determining the spatial motion trend based on visual information of the target at each sub-portion of a space for each audio frame, according to the first feature and a feature of the optical flow information.

Alternatively, the determining of the sound source motion trend within the target vision mask for each audio frame, based on the first feature, includes determining the sound source motion trend based on sound information of the target at each sub-portion of a space for each audio frame, according to the first feature.

Alternatively, the obtaining of the target sound mask of the target at each audio frame of the first audio signal, based on the first mask for each audio frame and the encoded features of the first audio signal, includes obtaining a global sound feature and a global motion trend feature of the target, based on the first mask for each audio frame and the encoded features of the first audio signal, wherein the global sound feature represents a feature of all sound related to the target, and the global motion trend feature represents motion trajectory information of the target in the first video, determining the target sound mask of the target at each audio frame, based on the global sound feature and the global motion trend feature.

Alternatively, the determining of the target sound mask of the target at each audio frame, based on the global sound feature and the global motion trend feature, includes updating the first mask for each audio frame, based on the global motion trend feature, determining the target sound mask of the target at each audio frame, based on the encoded features of the first audio signal, the global sound feature, and the updated first mask for each audio frame.

Alternatively, the determining of the target sound mask for the target at each audio frame based on the encoded features of the first audio signal, the global sound feature, and the updated first mask for each audio frame, includes eliminating a sound feature of a non-target from the encoded feature of each audio frame of the first audio signal, based on the global sound feature and the updated first mask for each audio frame, determining the target sound mask of the target at each audio frame, based on the encoded feature of each audio frame after the sound feature of the non-target is eliminated.

Alternatively, the obtaining of the second audio signal in which the sound related to the target is excluded, based on the target sound masks of the target at the respective moments and the first audio signal, includes removing, from the encoded features of the first audio signal, a feature of the sound related to the target based on the target sound mask of the target at each audio frame, to obtain non-target sound signal features of the first audio signal, obtaining the second audio signal based on the non-target sound signal features.

Alternatively, the obtaining of the second audio signal based on the non-target sound signal features, includes repairing the non-target sound signal features based on the updated first mask for each audio frame, to obtain the updated non-target sound signal features, obtaining the second audio signal by decoding the updated non-target sound signal features.

Alternatively, the updated first mask is obtained by obtaining a global motion trend feature based on the first mask for each audio frame and the encoded features of the first audio signal, updating the first mask for each audio frame based on the global motion trend feature.

Alternatively, the updating of the first mask for each audio frame based on the global motion trend feature, includes adjusting at least one of a spatial motion trend and a sound source motion trend in the first mask of a current audio frame, by comparing and performing trend consistency calculation on a motion trend of the target at the current audio frame and the global motion trend feature.

Alternatively, the repairing of the non-target sound signal features based on the updated first mask for each audio frame, to obtain the updated non-target sound signal features, includes obtaining a room impulse response of a non-target when being not obstructed by the target, based on the updated first mask for each audio frame and the non-target sound signal features, repairing the non-target sound signal features based on the room impulse response, to obtain the updated non-target sound signal features.

Alternatively, the obtaining of the room impulse response of the non-target when being not obstructed by the target, based on the updated first mask for each audio frame and the non-target sound signal features, includes selecting, from the non-target sound signal features, signal features of a plurality of audio frames before and/or after the non-target is obstructed by the target, based on the updated first mask for each audio frame, obtaining the room impulse response of the non-target when being not obstructed by the target, based on signal features corresponding to the plurality of audio frames.

In accordance with another aspect of the disclosure, an electronic apparatus is provided. The electronic apparatus includes memory, including one or more storage media, storing instructions, and at least one processor communicatively coupled to the memory, wherein the instructions, when executed by the at least one processor individually or collectively, cause the at least one processor to obtain target sound masks of a target in a first video at respective moments, based on image-related information of the target, a first audio signal corresponding to the first video, and direction information of the first audio signal, and obtain a second audio signal in which a sound related to the target is excluded, based on the target sound masks of the target at the respective moments and the first audio signal.

In accordance with another aspect of the disclosure, one or more non-transitory computer-readable storage media storing one or more computer programs including computer-executable instructions that, when executed by one or more processors of an electronic apparatus individually or collectively, cause the electronic apparatus to perform operations are provided. The operations include obtain target sound masks of a target in a first video at respective moments, based on image-related information of the target, a first audio signal corresponding to the first video, and direction information of the first audio signal, and obtain a second audio signal in which a sound related to the target is excluded, based on the target sound masks of the target at the respective moments and the first audio signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a diagram of a scheme for synchronously processing a sound during video inpainting according to an embodiment of the disclosure;

FIG. 2 is a diagram illustrating formation of a beam directing to a direction of a target mask based on a target mask and an audio signal according to an embodiment of the disclosure;

FIG. 3A is a diagram illustrating a target being obstructed or moving out of a screen according to an embodiment of the disclosure;

FIG. 3B is a diagram illustrating a target overlapping another sound source according to an embodiment of the disclosure;

FIG. 4A is a flowchart illustrating a method performed by an electronic apparatus according to an embodiment of the disclosure;

FIG. 4B is a schematic diagram illustrating a network structure corresponding to a method performed by an electronic apparatus according to an embodiment of the disclosure;

FIG. 4C is a diagram illustrating a changing situation of a sound signal spatial distribution and a target signal spatial distribution feature at two different time points before and after according to an embodiment of the disclosure;

FIG. 5A is a flowchart illustrating a process for obtaining a target dual-modal mask based on image-related information of a target and direction information according to an embodiment of the disclosure;

FIG. 5B is a schematic diagram illustrating a process for generating a target dual-modal mask by an auditory-visual feature analysis module according to an embodiment of the disclosure;

FIG. 6A is a diagram illustrating DOA information according to an embodiment of the disclosure;

FIG. 6B is a diagram illustrating a sound signal spatial distribution feature Xₛₚₐ according to an embodiment of the disclosure;

FIG. 7A illustrates a diagram of a target spatial distribution feature according to an embodiment of the disclosure;

FIG. 7B illustrates a spatial diagram of visual information according to an embodiment of the disclosure;

FIG. 7C illustrates a diagram of a discontinuous sound of a target according to an embodiment of the disclosure;

FIG. 7D illustrates a diagram of a position of a target overlapping other objects according to an embodiment of the disclosure;

FIG. 8 is a diagram illustrating a positional relationship between a sound signal spatial distribution feature and a target spatial distribution feature as well as a target dual-modal feature according to an embodiment of the disclosure;

FIG. 9 is a diagram illustrating obtaining a spatial motion trend based on visual information and a sound source motion trend based on sound information according to an embodiment of the disclosure;

FIG. 10A is a flowchart illustrating a process for obtaining a target sound mask of a target at each audio frame of a first audio signal according to an embodiment of the disclosure;

FIG. 10B is a schematic diagram illustrating a process for obtaining a target sound mask for a target at each audio frame of a first audio signal by a dual-modal dual-stage sound extraction module according to an embodiment of the disclosure;

FIG. 11 is a block diagram illustrating an encoder module according to an embodiment of the disclosure;

FIG. 12 is a network flowchart illustrating an encoder module according to an embodiment of the disclosure;

FIG. 13 is a schematic diagram illustrating a process for performing a feature processing on a target dual-modal mask and encoded features of a first audio signal by a global information analysis module according to an embodiment of the disclosure;

FIG. 14 is a diagram illustrating obtaining an updated target dual-modal mask according to an embodiment of the disclosure;

FIG. 15 is a diagram illustrating obtaining a target sound mask of a target at a current audio frame according to an embodiment of the disclosure;

FIG. 16 illustrates a schematic diagram of a network structure corresponding to a method performed by an electronic apparatus according to an embodiment of the disclosure;

FIG. 17 is a schematic diagram illustrating a structure of a repair module according to an embodiment of the disclosure;

FIG. 18 is a block diagram illustrating a decoder module according to an embodiment of the disclosure;

FIG. 19 illustrates a schematic diagram of applying a method performed by an electronic apparatus in a scenario where a target overlaps with other sound sources when a video is recorded according to an embodiment of the disclosure;

FIG. 20 illustrates a schematic diagram of applying a method performed by an electronic apparatus in a scenario where a target is not within a screen when a video is recorded according to an embodiment of the disclosure; and

FIG. 21 is a schematic diagram of a structure illustrating of an electronic apparatus according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a”, “an,” and “the” include plural referents unless the context clearly dictates otherwise. Thus, for example, reference to “a component surface” includes reference to one or more such surfaces.

When it refers to one element as being “connected” or “coupled” to another element, the one element may be directly connected or coupled to the other element, or it may refer to a connection relationship between the one element and the other element established through an intermediate element. In addition, “connected” or “coupled” as used herein may include wirelessly connected or wirelessly coupled.

The term “include” or “may include” refers to the presence of a function, operation, or component of the corresponding disclosure that may be used in the various embodiments of the disclosure, and does not limit the presence of one or more additional functions, operations, or features. In addition, the terms “include” or “have” may be interpreted to denote certain features, figures, steps, operations, constituent elements, components, or combinations thereof, but should not be interpreted to exclude the possibility of the presence of one or more other features, figures, steps, operations, constituent elements, components, or combinations thereof.

The term “or” as used in the various embodiments of the disclosure includes any of the listed terms and all combinations thereof. For example, “A or B” may include A, may include B, or may include both A and B. When describing a plurality of (two or more) items, the plurality of items may refer to one, more, or all of the plurality of items if a relationship among the plurality of items is not explicitly defined. For example, for the description “a parameter A comprises A1, A2, A3”, it may be implemented as parameter A comprising A1, A2 or A3, or as parameter A comprising at least two of the three items of the parameter A1, A2, A3.

All terms (including technical or scientific terms) used in the disclosure have the same meaning as understood by those skilled in the art to which the disclosure belongs, unless defined differently. Common terms as defined in dictionaries are interpreted to have a meaning consistent with the context in the relevant technology art and should not be interpreted in an idealized or overly formalistic manner, unless expressly so defined in the disclosure.

At least part of the functions in a device or electronic apparatus provided in the embodiments of the disclosure may be implemented through an AI model, such as, at least one of a plurality of modules of the device or electronic apparatus may be implemented through the AI model. A function associated with AI may be performed through non-volatile memory, volatile memory, and the processor.

The processor may include one or more processors. At this time, the one or more processors may be a general purpose processor, such as a central processing unit (CPU), an application processor (AP), or the like, or may be a graphics-only processing unit, such as a graphics processing unit (GPU), a visual processing unit (VPU), and/or an AI-dedicated processor, such as a neural processing unit (NPU).

The one or more processors control processing of input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning algorithm to a plurality of learning data, a predefined operating rule or an AI model of a desired characteristic is made. The learning may be performed in a device or electronic apparatus itself in which AI according to an embodiment is performed, and/or may be implemented through a separate server/system.

The AI model may consist of a plurality of neural network layers. Each layer has a plurality of weight values, and performs a neural network calculation by calculating between the input data of this layer (such as, a calculation result of the previous layer and/or the input data of the AI model) and the plurality of weight values of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial networks (GAN), and a deep Q-network.

The learning algorithm is a method for training a predetermined target device (for example, a robot) using a plurality of learning data to cause, allow, or control the target device to make a determination or prediction. Examples of the learning algorithm include, but are not limited to, supervised learning, unsupervised learning, semi-supervised learning, or reinforcement learning.

The methods provided in the disclosure may involve one or more of technical fields, such as speech, language, image, video, or data intelligence.

Alternatively, when involving the field of speech or language, in the method according to the disclosure executed by electronic apparatus, a speech signal, which is an analog signal, may be received via speech input devices (e.g., a microphone), and the speech part is converted into computer readable text using an automatic speech recognition (ASR) model. The user's intent of utterance may be obtained by interpreting the converted text using a natural language understanding (NLU) model. The ASR model or NLU model may be an artificial intelligence model. The artificial intelligence model may be processed by an artificial intelligence-dedicated processor designed in a hardware structure specified for artificial intelligence model processing. Language understanding is a technique for recognizing and applying/processing human language/text and includes, e.g., natural language processing, machine translation, dialog system, question answering, or speech recognition/synthesis.

Alternatively, when involving the field of image or video, in the method according to the disclosure executed by electronic apparatus, output data may be obtained by using image data as input data for an artificial intelligence model. The method of the disclosure may involve the field of visual understanding in the artificial intelligence technology, and the visual understanding is a technique for recognizing and processing things as does human vision and includes, e.g., object recognition, object tracking, image retrieval, human recognition, scene recognition, three dimension (3D) reconstruction/localization, or image enhancement.

Alternatively, when involving the field of data intelligence processing, in the method according to the disclosure executed by electronic apparatus, in the reasoning or predicting stage, an artificial intelligence model can be used to perform predictions by using real-time input data. Processors of the electronic apparatus may perform a pre-processing operation on the data to convert into a form appropriate for use as an input for the artificial intelligence model. Reasoning and prediction is a technique of logically reasoning and predicting by determining information and includes, e.g., knowledge-based reasoning, optimization prediction, preference-based planning, or recommendation.

In an embodiment of the disclosure, the artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

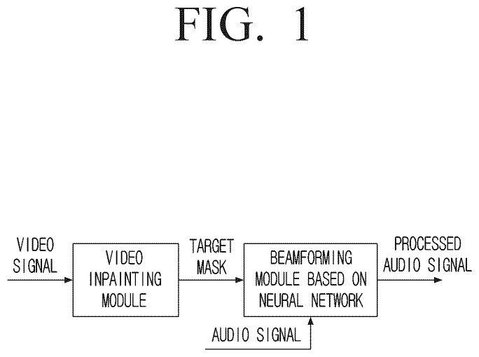

FIG. 1 illustrates a diagram of a scheme for synchronously processing a sound during video inpainting according to an embodiment of the disclosure.

Referring to FIG. 1, a video inpainting module repairs an input video, e.g., removes a target in the video, this scheme may obtain a target mask (or positional information) of a target to be removed by utilizing visual information provided by the video inpainting module, then may determine which direction the sound is to be eliminated is coming from, by utilizing the target mask. In one embodiment of the disclosure, the target mask may be obtained by labeling the target to be removed (i.e., a pedestrian).

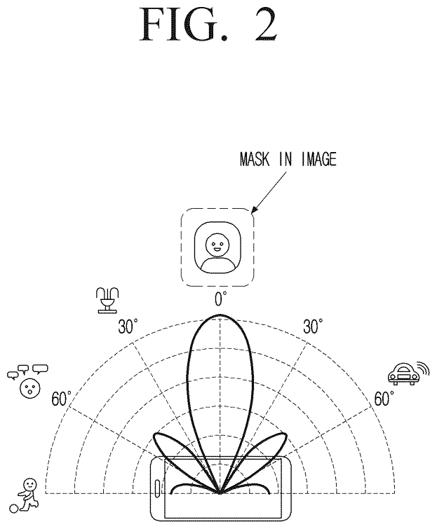

FIG. 2 is a diagram illustrating formation of a beam directing to a direction of a target mask based on a target mask and an audio signal according to an embodiment of the disclosure.

Referring to FIG. 2, this scheme forms a beam directing to a direction of the target mask based on the target mask and an audio signal, by a beamforming module based on a neural network, thereby extracting a sound in a specified direction and simultaneously suppressing sounds in other directions, to realize extraction of the sound of the target. Finally, this system removes the extracted sound of the target from the audio signal.

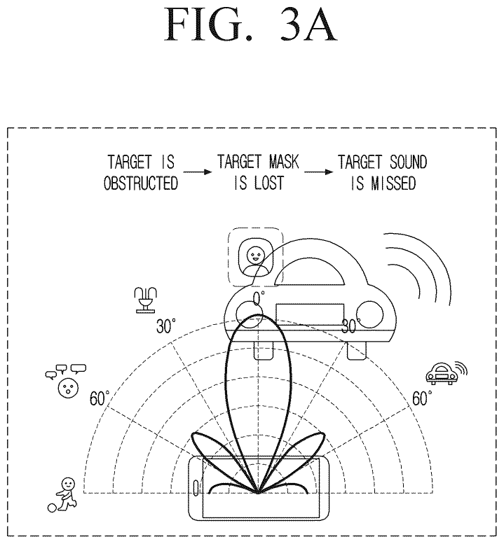

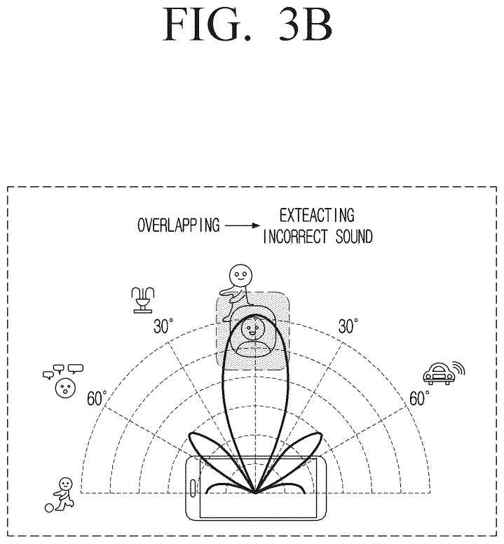

FIG. 3A is a diagram illustrating a target being obstructed or moving out of a screen according to an embodiment of the disclosure. FIG. 3B is a diagram illustrating a target overlapping another sound source according to an embodiment of the disclosure.

However, the above scheme for directly synchronizing processing of the sound during the video inpainting does not accurately extract or remove the sound of the target, the sound of the target remains in the processed sound, or a sound other than the sound of the target is incorrectly deleted, for example, the following three cases:
(1) In most cases, the target mask is continuous between each image frame in the video, but when the target is blocked or moves out of the screen, the video inpainting module cannot provide information of the target mask, which will result in loss of the visual mask information of the target, and cannot extract the sound of the target. Thus, when the target is blocked or moves out of the screen, the sound of the target cannot be removed, referring to FIG. 3A.
(2) When the target overlaps with another sound source, a direction of a sound of the overlapping sound source is the same or similar to a direction of the target, which will cause the above scheme to incorrectly extract the sound of the overlapping sound source, referring to FIG. 3B. In addition, considering that the sound of the target is mostly discontinuous, there may be a case where there is no sound of the target at some moments, and when the target overlaps with the other sound source at that moment, the sound of the other sound source may also be incorrectly extracted using the above scheme.
(3) In an actual scenario, the target generates a variety of sounds, for example, when a person who is the target is running, the sound of the target includes not only sound of talk, but also sound of footsteps or sounds caused by other movements. Using the above scheme or other schemes, it is not possible to obtain all the sounds of the target, and thus it is not possible to remove the sound of the target cleanly.

To this end, the disclosure proposes a method performed by an electronic apparatus, which is capable of, when the target is removed in video inpainting, extracting and removing a sound of a target, thereby enhancing user experience. Specifically, the method analyzes and estimates a target dual-modal mask of the target at each audio frame, firstly utilizing spatial information of the target (including an azimuthal distance, a movement direction, and a speed of the target) obtained from the video inpainting module as well as a spatial distribution of the sound signal. Then, obtaining a global sound feature and a global motion trend feature of the target by analyzing an entire segment of an input audio signal frame by frame, and based on the global motion trend feature of the target and the target dual-modal mask of the target, obtaining a more accurate target dual-modal mask by updating, and obtaining a target sound mask for each audio frame by analyzing a feature of each audio frame of the audio signal, the global sound feature, and the updated target dual-modal mask, wherein the target sound mask represents a part of the target sound feature among audio features of the audio frames and may also be understood as a percentage of information for which the sound of the target accounts in each audio frame of the first audio signal. Finally, another sound source is repaired by analyzing a sound wave propagation path (more particularly, a sound of a sound source that is obstructed by the target is repaired), thereby simulating a sound propagation and a auditory sensation of the other sound source when the target is not present in the actual scenario.

Below, the technical solutions of the embodiments of the disclosure and the technical effects produced by the technical solutions of the disclosure will be explained by describing several optional embodiments. It should be noted that, the following embodiments may be referred to, imitated or combined with each other, and the same term, similar features and similar implementation steps in different embodiments will not be described repeatedly.

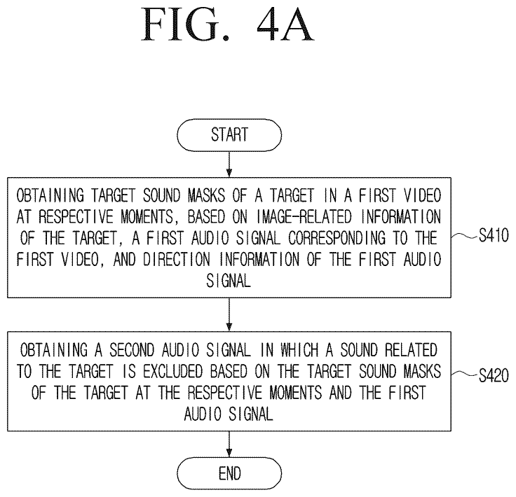

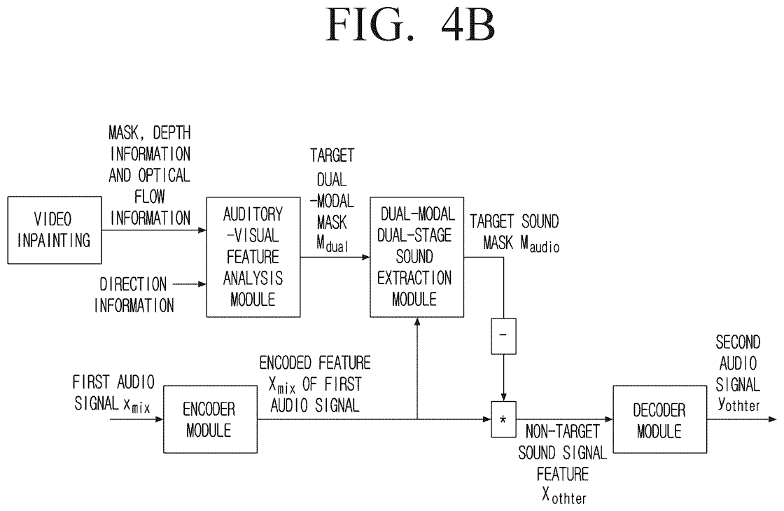

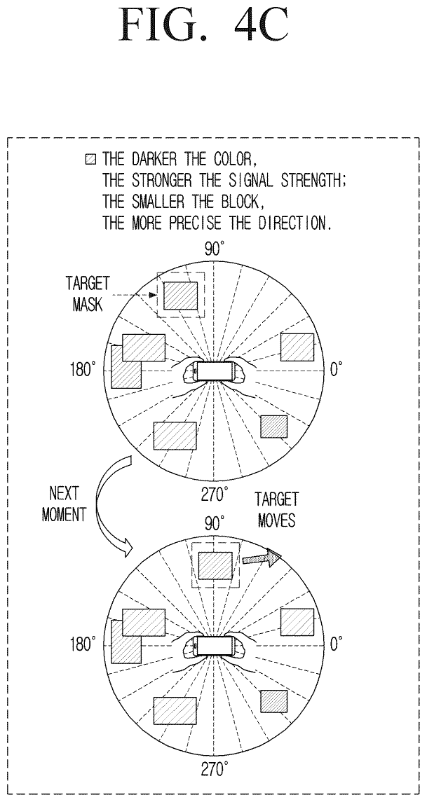

FIG. 4A is a flowchart illustrating a method performed by an electronic apparatus according to an embodiment of the disclosure. FIG. 4B is a schematic diagram illustrating a network structure corresponding to a method performed by an electronic apparatus according to an embodiment of the disclosure. FIG. 4C is a diagram illustrating a changing situation of a sound signal spatial distribution and a target signal spatial distribution feature at two different time points before and after according to an embodiment of the disclosure.

Functions of respective modules illustrated therein is described below firstly in connection with FIG. 4B.

Referring to FIG. 4B, a first video is a video input to a video inpainting module. The video inpainting module may repair the first video according to an operation instruction (e.g., a remove instruction or a repair instruction) for a target, such as, remove the target. An encoder module performs feature encoding (e.g., performs a discrete Fourier transform) on a first audio signal corresponding to the first video, to obtain encoded features of the first audio signal, which are high-dimensional feature vectors for characterizing information in different dimensions of a speech.

A auditory-visual feature analysis module may obtain image-related information of the target from the video inpainting module, and in the disclosure, “image-related information of the target” may also be referred to as “spatial information of the target”, and the image-related information of the target may include a target vision mask, depth information, and optical flow information of the target. Wherein the target vision mask may represent an area where the target to be removed selected by a user is located, and the depth information of the target may represent a distance between the target in the image/video and a camera, and the optical flow information of the target represents a motion direction and a motion speed of the target, and furthermore, a spatial position and a distance of the target may be obtained by utilizing the target vision mask and depth information. The auditory-visual feature analysis module may also obtain direction information (for example, direction of arrival (DOA) information) of the first audio signal at different moments from, for example, outside. The auditory-visual feature analysis module obtains a sound signal spatial distribution feature and a target spatial distribution feature of the target by analyzing these obtained information, e.g., FIG. 4C illustrates a changing situation of a sound signal spatial distribution (e.g., a target represented by a solid box moving from upper-left to directly above) and a target signal spatial distribution feature (e.g., a target mask represented by a dashed box moving from upper-left to directly above) at two different moments before and after, and the auditory-visual feature analysis module finally obtains a target dual-modal mask by jointly analyzing these features. In the disclosure, the “target dual-modal mask” may also be referred to as a “first mask”, which contains spatial position information of the target, a motion trend of a mask, and a direction of motion of a sound source.

A dual-modal dual-stage sound extraction module obtains a target sound mask of each audio frame by adopting a dual-stage analysis. Briefly, this module firstly obtains a global sound feature and a global motion trend feature of the target by analyzing an entire segment of the first audio signal frame by frame, and then, corrects and updates the target dual-modal mask for each audio frame using the obtained global motion trend feature, to obtain a more accurate target dual-modal mask for each audio frame, and finally analyzes encoding features of the first audio signal based on the global sound feature of the target and the target dual-modal mask for each audio frame, to obtain the target sound mask of the target at each audio frame, wherein the target sound mask for each audio frame may represent a percentage of information for which a sound of the target accounts in each audio frame, and thereby, a percentage for which a sound of a non-target accounts in each audio frame of the first audio signal may also be obtained (a sum of these two percentages is 1).

The decoder module decodes the encoded features of the first audio signal after a sound feature of the target is removed from the encoded features using the target sound mask, to obtain a second audio signal.

Referring to FIG. 4A, at operation S410, target sound masks of a target in a first video at respective moments are obtained, based on image-related information of the target, a first audio signal corresponding to the first video, and direction information of the first audio signal. In the following descriptions of the disclosure, descriptions are made by taking an example of the “respective moments” being the time corresponding to each audio frame of the first audio signal, but the disclosure is not limited thereto, and the “respective moments” may be the time corresponding to each two audio frames of the first audio signal, or may be the time corresponding to each video frame of the first video, and the disclosure does not make any specific limitation thereon.

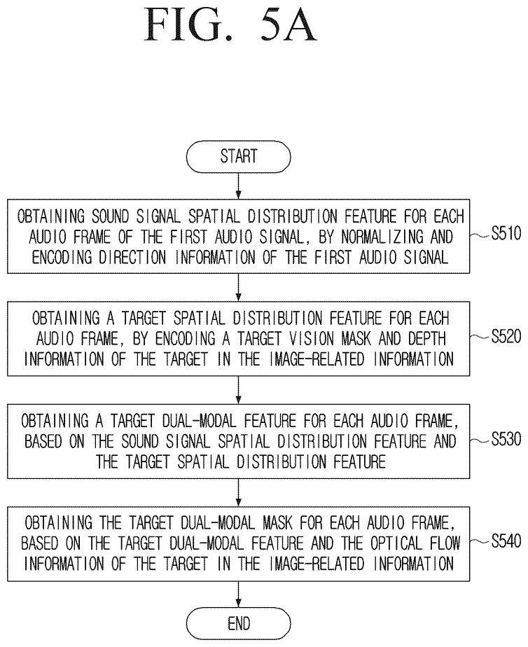

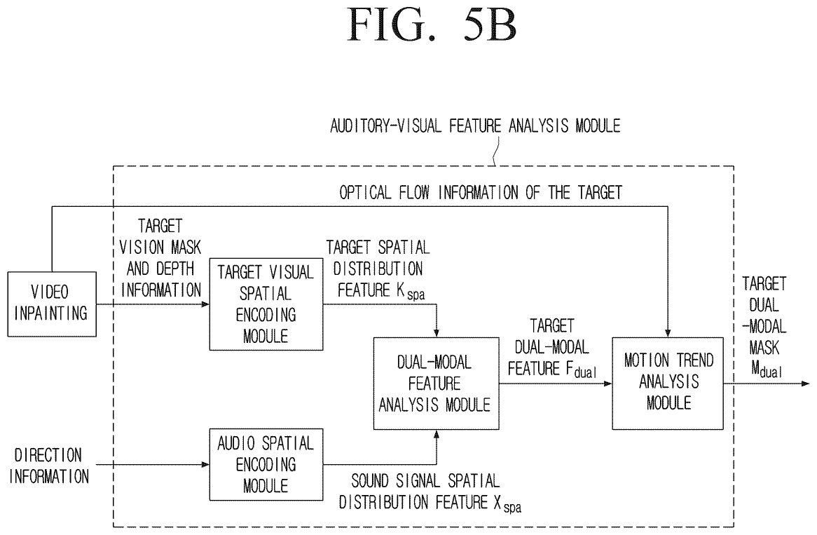

Specifically, operation S410 may include obtaining a target dual-modal mask for each audio frame of the first audio signal, based on the image-related information and the direction information, and obtaining the target sound mask of the target at each audio frame of the first audio signal, based on the target dual-modal mask for each audio frame and encoded features of the first audio signal. A process of obtaining the target dual-modal mask will be described below with reference to FIGS. 5A and 5B.

FIG. 5A is a flowchart illustrating a process of obtaining a target dual-modal mask based on image-related information of a target and direction information according to an embodiment of the disclosure. FIG. 5B is a flowchart illustrating a process for generating a target dual-modal mask by an auditory-visual feature analysis module according to an embodiment of the disclosure.

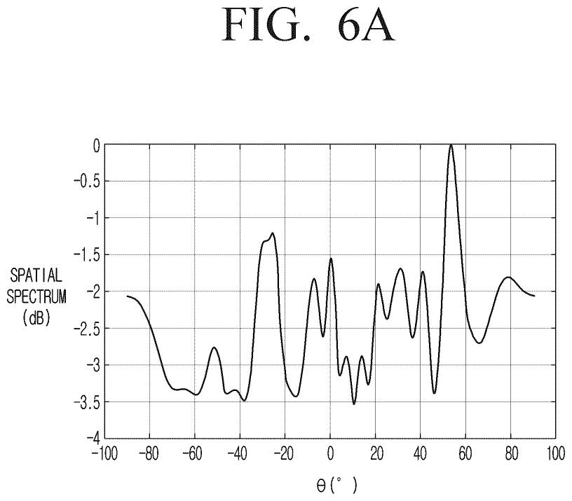

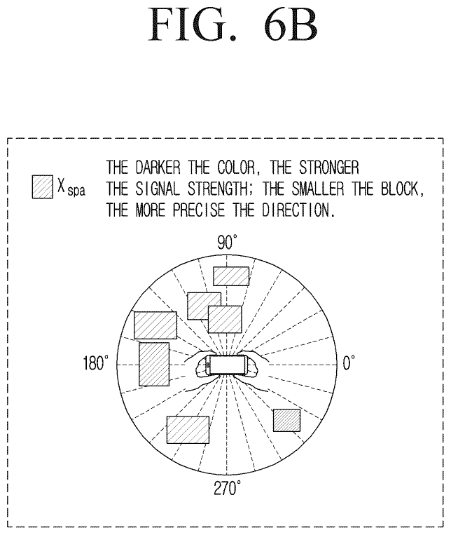

FIG. 6A is a diagram illustrating DOA information according to an embodiment of the disclosure. FIG. 6B is a diagram illustrating a sound signal spatial distribution feature Xₛₚₐ according to an embodiment of the disclosure.

Referring to FIG. 5A, at operation S510, a sound signal spatial distribution feature is obtained for each audio frame of the first audio signal, by normalizing and encoding direction information of the first audio signal.

Specifically, referring to FIG. 5B, the auditory-visual feature analysis module may include a target visual spatial encoding module, an audio spatial encoding module, a dual-modal feature analysis module, and a motion trend analysis module, each of which may be implemented by a network capable of implementing feature processing, such as a convolutional network, an attention network, or a recursive network, and so on. Operation S510 may be performed by the audio spatial encoding module. The audio spatial encoding module may obtain the direction information of the first audio signal at different moments (e.g., each audio frame) from, for example, outside, and in the following descriptions, the direction information of the first audio signal at different moments being DOA information is illustrated as an example, this DOA information may be obtained by processing signals of a plurality of microphones through a MUSIC method, referring to FIG. 6A. But the disclosure is not limited to. The direction information of the first audio signal at different moments may also be other direction information. The audio spatial encoding module perform the normalization and encoding operations on the DOA information of the first audio signal at each audio frame using the neural network, thereby realizing mapping of the same into a feature space, so as to obtain a sound signal spatial distribution feature Xₛₚₐ for each audio frame, which may represent a strength and a probability of existence of a signal in each direction in a space of 0 to 360 degrees. By analyzing the DOA information one audio frame-by-one audio frame, a motion direction of a sound source may be obtained. FIG. 6B is a diagram illustrating one example of the sound signal spatial distribution feature Xₛₚₐ, wherein since the sound signal spatial distribution feature is obtained by analyzing the DOA information, however, usually there are a limited number of microphones (e.g., usually there are 2-4 microphones) on an electronic apparatus, it is not possible to accurately locate a position of the sound source, and only a rough direction of the sound may be obtained. Thus, positions of respective sound sources appear as blocks or areas rather than points, on the sound signal spatial distribution feature Xₛₚₐ shown in FIG. 6B. In addition, in the disclosure, the audio spatial encoding module may be implemented by using a convolutional network, however, the disclosure is not limited to this, and it may also be implemented by using another network (e.g., a recurrent network, an attention network, or the like) having a feature processing capability.

At operation S520, a target spatial distribution feature is obtained for each audio frame, by encoding a target vision mask and depth information of the target in the image-related information.

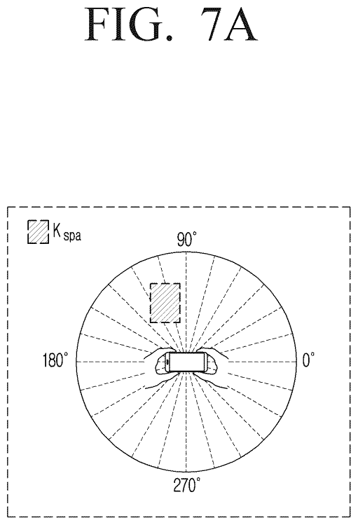

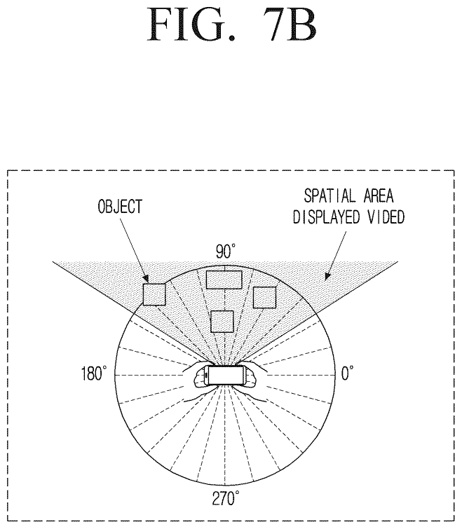

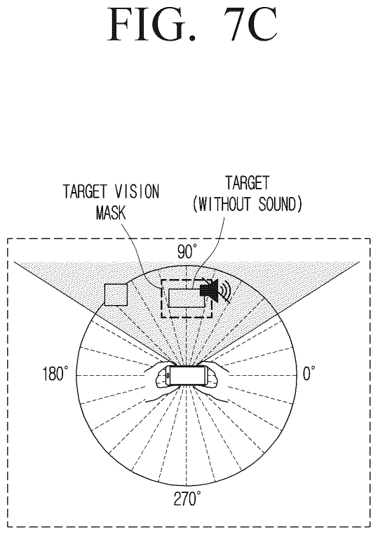

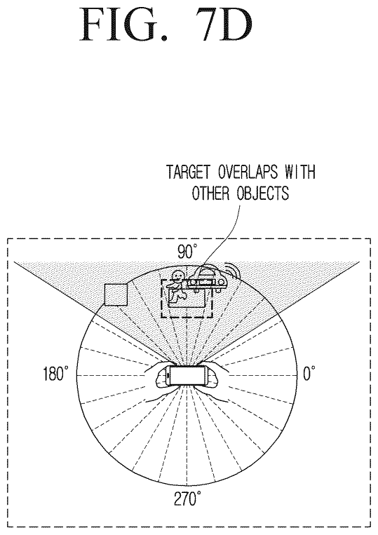

Specifically, operation S520 may be performed by a target visual spatial encoding module. Referring to FIG. 5B, the target visual spatial encoding module may obtain the target vision mask and the depth information of the target corresponding to each audio frame from outside (e.g., the video inpainting module), and encode the target vision mask and the depth information of the target by utilizing the neural network, realizing the mapping of the same into a sound spatial distribution, so as to obtain a target spatial distribution feature Kₛₚₐ for each audio frame, referring to FIG. 7A. In other words, the target visual spatial encoding module may determine, for each audio frame, a position where the target is located in a space by utilizing the target vision mask and the depth information of the target. In addition, in the disclosure, the target visual spatial encoding module may be implemented using any network capable of implementing feature processing, for example, a convolutional network, an attention network, or a recursive network, or the like, may be used.

FIG. 7A illustrates a diagram of a target spatial distribution feature according to an embodiment of the disclosure. FIG. 7B illustrates a spatial diagram of visual information according to an embodiment of the disclosure. FIG. 7C illustrates a diagram of a discontinuous sound of a target according to an embodiment of the disclosure. FIG. 7D illustrates a diagram of a position of a target overlapping other objects according to an embodiment of the disclosure.

Referring to FIGS. 7A, 7B, 7C, and 7D, since the visual information (e.g., the target vision mask and the depth information of the target) and the sound have different feature distributions, for example, the visual information includes only a directly front of the electronic apparatus (referring to FIG. 7B), and sound information includes 360-degree omni-direction information, and for another example, the feature distribution of the visual information is inconsistent with a sound feature distribution due to the fact that the feature distribution of the visual information is based on feature vectors obtained by an image/video algorithm and the sound feature distribution is based on feature vectors obtained by an audio algorithm, the both are on different feature spaces. In addition, since the visual information of the target in the first video is continuous (i.e., there is continuity between image frames), but the sound of the target is often discontinuous, e.g., for a case where the target is a pedestrian, the sound of the target may have intervals and be intermittent (as illustrated in FIG. 7C), and furthermore, the target may move out of the screen or be obstructed by another object (i.e., a non-target), but the sound of the target still exists, and in addition, the position of the target may overlap with another object (i.e., the non-target), and a sound direction of the overlapping object is the same as a sound direction of the target (as illustrated in FIG. 7D), all of which will result in inconsistency of information expressed by the visual features and information expressed by the sound features. To this end, in the disclosure, the target visual spatial encoding module encodes the target vision mask and the depth information of the target by utilizing the neural network, thereby realizing the mapping of them into the sound spatial distribution, thereby facilitating a subsequent processing for joint processing of multiple features. In addition, since a frame rate of a video is usually 24 to 50 frames per second, and a frame rate of an audio is usually 50 frames per second, a video feature processing and an audio feature processing are consistent in terms of a time span.

At operation S530, a target dual-modal feature is obtained for each audio frame, based on the sound signal spatial distribution feature and the target spatial distribution feature. In the disclosure, the “target dual-modal feature” may be referred to as a “first feature”.

Specifically, operation S530 may be performed by the dual-modal feature analysis module that maps visual features of the target to spatial features of the sound distribution, thereby obtaining the target dual-modal feature for each audio frame. Referring to FIG. 5B, the dual-modal feature analysis module may obtain the target spatial distribution feature Kₛₚₐ for each audio frame from the target visual spatial encoding module, and obtain the sound signal spatial distribution feature Xₛₚₐ for each audio frame from the audio spatial encoding module, and may then perform a feature processing on the sound signal spatial distribution feature Xₛₚₐ and the target spatial distribution feature Kₛₚₐ to obtain a target dual-modal feature F_{dual} for each audio frame. The feature processing may be, for example, a convolutional processing, a fusion processing, a concatenating processing, and the like. In the disclosure, for each audio frame, the target dual-modal feature F_{dual} represents the position of the target in the space and a direction of a sound contained in the target vision mask obtained, for example, from the video inpainting module. Furthermore, the “sound contained in the target vision mask” may not necessarily be the sound of the target, e.g., when a certain sound source is just located in a spatial position corresponding to the target vision mask, the “sound contained in the target vision mask” may contain a sound of this sound source.

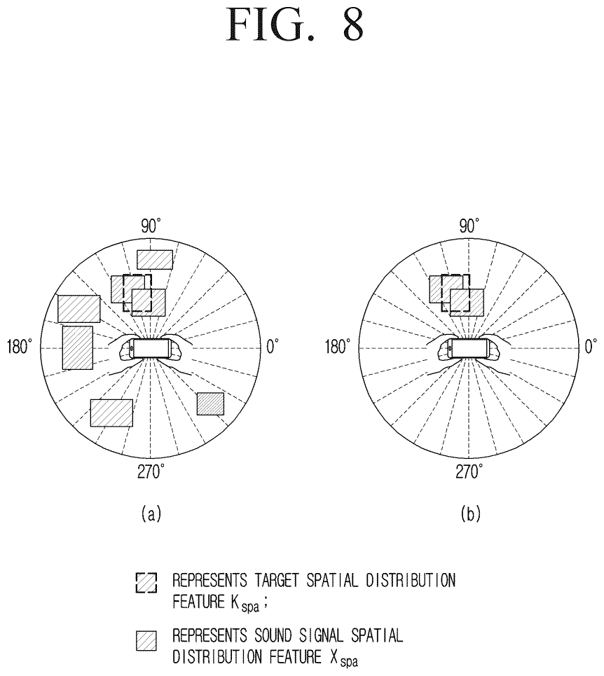

FIG. 8 is a diagram illustrating a positional relationship between a sound signal spatial distribution feature and a target spatial distribution feature as well as a target dual-modal feature according to an embodiment of the disclosure.

Referring to part (a) of FIG. 8, there are two sound sources in a spatial position corresponding to a target vision mask, and one of them may be a sound source other than the target, this is because, due to an interference of the sound, sound positioning obtained according to the DOA information is not accurate enough, a sound source feature that is near to the target spatial distribution feature Kₛₚₐ will also be considered as a candidate sound source of the target. Furthermore, since only the sound of the target needs to be considered in the disclosure, the disclosure will discard sound information that is far away from the target spatial distribution feature Kₛₚₐ in the feature space. For example, part (b) of FIG. 8 only shows the sound information on the spatial position corresponding to the target spatial distribution feature Kₛₚₐ.

At operation S540, the target dual-modal mask is obtained for each audio frame, based on the target dual-modal feature and optical flow information of the target in the image-related information.

Specifically, operation S540 may be performed by the motion trend analysis module. Referring to FIG. 5B, the motion trend analysis module may obtain the target dual-modal feature F_{dual} from the dual-modal feature analysis module. The motion trend analysis module may determine a spatial motion trend of the target for each audio frame based on the target dual-modal feature F_{dual} and the optical flow information of the target (in other words, analyze the spatial motion trend of the target one audio-frame-by-one audio-frame based on the target dual-modal feature F_{dual} and the optical flow information of the target), determine a sound source motion trend within the target vision mask based on the target dual-modal feature F_{dual} for each audio frame (in other words, analyze the sound source motion trend within the target vision mask one audio-frame-by-one audio-frame based on the target dual-modal feature F_{dual}), and obtaining the target dual-modal mask M_{dual} for each audio frame based on a determination result (or an analysis result) of the spatial motion trend and a determination result (or an analysis result) of the sound source motion trend.

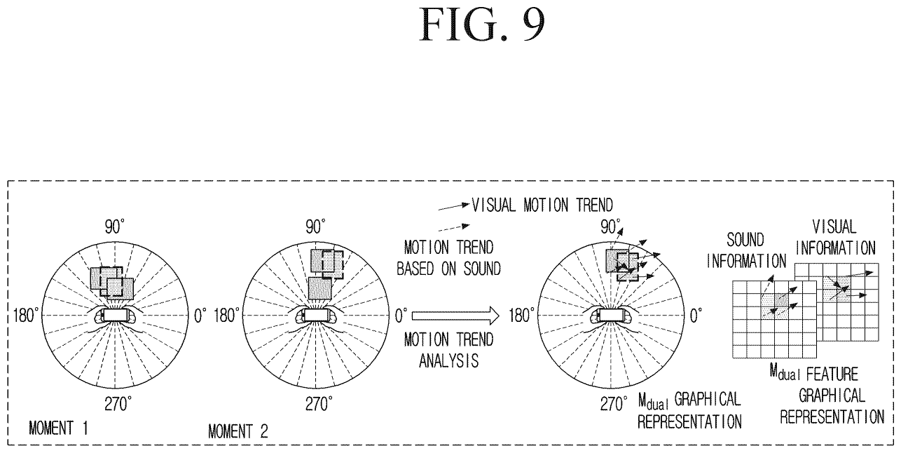

FIG. 9 is a diagram illustrating obtaining a spatial motion trend based on visual information and a sound source motion trend based on sound information according to an embodiment of the disclosure.

Referring to FIG. 9, the determining of the spatial motion trend of the target for each audio frame based on the target dual-modal feature and the optical flow information may include: determining “the spatial motion trend based on visual information” of the target at each sub-portion of the space for each audio frame, according to the target dual-modal feature F_{dual} and a feature of the optical flow information. In other words, the spatial motion trend based on the visual information (may also be referred to as “visual motion trend”) of the target at each sub-portion of the space for each moment is determined, by analyzing changes in the target dual-modal feature F_{dual} and the feature of the target optical flow information between two adjacent audio frames. For example, the motion trend analysis module may, by analyzing the changes of the dual-modal feature F_{dual} and the feature of the optical flow information of the target between a current audio frame and a previous audio frame, obtain “the spatial motion trend based on the visual information” of the target in respective sub-spaces within the target vision mask (i.e., each sub-portion of the target in the space, such as an upper-left, upper-right, lower-left, and lower-right sub-portions) at the current audio frame (or a current moment corresponding to the current audio frame), as in an example shown in FIG. 9, each sub-space has a relatively consistent spatial motion trend (all rightward), and at the same time, the spatial motion trend of each sub-space may be slightly different due to different motion direction of each sub-space at an instantaneous moment, a presence of an interference and/or a bias of an algorithmic estimation. For example, although spatial motion trends of the upper-left sub-space and the lower-left sub-space are both rightward, the spatial motion trend of the upper-left subspace is toward a lower-right direction and the spatial motion trend of the lower-left subspace is toward an upper-right direction.

Furthermore, the step of determining the sound source motion trend within the target vision mask for each audio frame based on the target dual-modal feature may include: determining the sound source motion trend based on sound information of the target at each sub-portion of the space for each audio frame, according to the target dual-modal feature F_{dual}. In other words, by analyzing changes and correlations of the target dual-modal feature F_{dual} between two adjacent audio frames, the sound source motion trend based on the sound information (may also be referred to as “sound-based motion trend”) of the target at each sub-portion of the space for each moment is determined. For example, the motion trend analysis module may, by analyzing the variations and correlations of the target dual-modal feature F_{dual} between the current audio frame and the previous audio frame, obtain “the sound source motion trend based on the sound information” of the target at respective sub-spaces within the spatial distribution (i.e., each sub-portion of the target at the space, such as the upper-left, upper-right, lower-left, and lower-right sub-portions of the target at the space) at the current audio frame (or a current moment corresponding to the current audio frame), referring to FIG. 9, each subspace has a relatively consistent spatial motion trend (all rightward), and at the same time, the spatial motion trend of each sub-space may be slightly different due to different motion direction of each sub-space at an instantaneous moment, a presence of an interference and/or a bias of an algorithmic estimation. For example, although spatial motion trends of the upper-left sub-space and the lower-left sub-space are both rightward, but the spatial motion trend of the upper-left sub-space is more upward than the spatial motion trend of the lower-left subspace.

By the above motion trend analysis, the motion trend analysis module may obtain the target dual-modal mask M_{dual} for each audio frame, referring to FIG. 9.

In the process of obtaining the target dual-modal mask described above with reference to FIG. 5A, the auditory-visual feature analysis module synchronizes two types of information of the visual information and the sound information. In the disclosure, the visual information may enable the neural network to focus only on the sound information of the sound within or closer to the target vision mask, meanwhile the sound information may enable the neural network not to miss sound features of the target when the neural network lost the visual information, and furthermore, the spatial motion trend based on the visual information and the sound source motion trend based on the sound information may enable the neural network to obtain a more accurate motion trajectory of the target, thereby extracting more accurate sound features.

Returning to reference to FIGS. 4A and 4B, in operation S410, after the target dual-modal mask is obtained, the dual-modal dual-stage sound extraction module may obtain the target sound mask of the target at each audio frame of the first audio signal, based on the target dual-modal mask for each audio frame and the encoded features of the first audio signal.

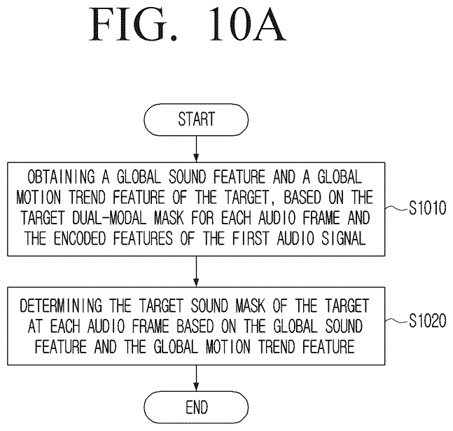

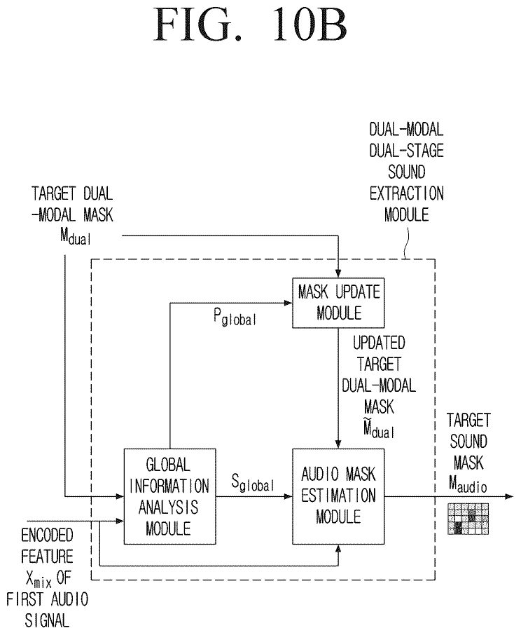

A process for obtaining the target sound mask of the target at each audio frame of the first audio signal will be described below with reference to FIGS. 10A and 10B.

FIG. 10A is a flowchart illustrating a process of obtaining a target sound mask of a target at each audio frame of a first audio signal according to an embodiment of the disclosure. FIG. 10B is a flowchart illustrating a process of obtaining a target sound mask of a target at each audio frame of a first audio signal by a dual-modal dual-stage sound extraction module according to an embodiment of the disclosure. Referring to FIG. 10B, a dual-modal dual-stage sound extraction module may include a global information analysis module, a mask update module, and an audio mask estimation module.

Referring to FIG. 10A, at operation S1010, a global sound feature and a global motion trend feature of the target are obtained, based on the target dual-modal mask for each audio frame and the encoded features of the first audio signal, wherein the global sound feature represents a feature of all sound related to the target, and the global motion trend feature represents motion trajectory information of the target in the first video.

Specifically, operation S1010 may be performed by the global information analysis module. Referring to FIG. 10B, the global information analysis module may obtain the target dual-modal mask M_{dual} corresponding to each audio frame of the first audio signal from the auditory-visual feature analysis module, and obtain the encoded features (may also be referred to as mixed audio features Xₘᵢₓ) of the first audio signal from the encoder module. Then, the global information analysis module may analyze all the encoded features of the first audio signal based on the target dual-modal mask M_{dual} of each audio frame, to obtain a global sound feature S_{global} and a global motion trend feature P_{global} of the target, For example, may perform a convolution processing, a fusion processing on the target dual-modal mask M_{dual} of each audio frame of the first audio signal and the encoded features of the first audio signal through a neural network, to achieve a comparison on spatial information and sound feature between the target and the interference, thereby obtaining the global sound feature S_{global} and the global motion trend feature P_{global} of the target. In the disclosure, when the global sound feature S_{global} and the global motion trend feature P_{global} of the target are obtained by analyzing an entire segment of the first audio signal, finally only one global sound feature S_{global} and one global motion trend feature P_{global} may be obtained. In the disclosure, the global sound feature S_{global} represents a feature of all sound related to the target, such as a feature of sound of talk, footsteps, clothing rubbing, and so on of the target, and the global motion trend feature P_{global} represents motion trajectory information of the target in in the entire first video.

In another embodiment of the disclosure, when the global sound feature and the global motion trend feature are obtained, the global information analysis module may divide the first audio signal into a plurality of segments of audio signals, and obtain one corresponding global sound feature and one global motion trend feature for each of the plurality of segments of audio signals. Specifically, the global information analysis module may decide whether to divide the first audio signal into the plurality of segments of audio signals, or decide whether to increase or decrease a length of each segment of audio signal in the plurality of segments of audio signals divided from the first audio signal, for example, according to at least one of a performance of the previously obtained second audio signal, an actual use scenario, a performance of the electronic apparatus, and the like. For example, if a sound related to the target remains in the previously obtained second audio signal (i.e., the sound related to the target is not completely removed), the global information analysis module may increase the length of each segment of the audio signal divided from the first audio signal (accordingly, decrease the number of the plurality of segments of audio signals divided), thereby ensuring that accuracy of the global sound feature and the global motion trend feature obtained for each segment of audio signal. For example, if the actual use scenario is more complex, there are multiple sound sources, or an overlapping degree between sound generated by another sound source and the sound of the target exceeds a predetermined threshold (i.e., the overlapping degree is high), the global information analysis module may increase the length of each segment of audio signal divided from the first audio signal, thereby ensuring the accuracy of the global sound feature and global motion trend feature obtained for each segment of audio signal (i.e., ensuring accuracy of global information). For another example, if the electronic apparatus requires that a time delay for processing the audio signal be less than a certain time, the global information analyzing module may determine the length of each segment of audio signal divided from the first audio signal based on the required time delay.

Furthermore, when the first audio signal is divided into the plurality of segments of audio signals, the global sound feature and the global motion trend feature obtained for any one of the plurality of segments of audio signals may be used as an initial global sound feature and an initial global motion trend feature for a next segment of audio signal of this segment of audio signal, and update the initial global sound feature and the initial global motion trend feature by analyzing this next audio signal, thereby obtaining the global sound feature and the global motion trend feature for this next segment of the audio signal. However, the disclosure is not limited thereto, the global sound feature and the global motion trend feature obtained for the previous audio signal may not be used as initial values, and the global sound feature and the global motion trend feature may be obtained directly according to operation of operation S1010, for this next audio signal.

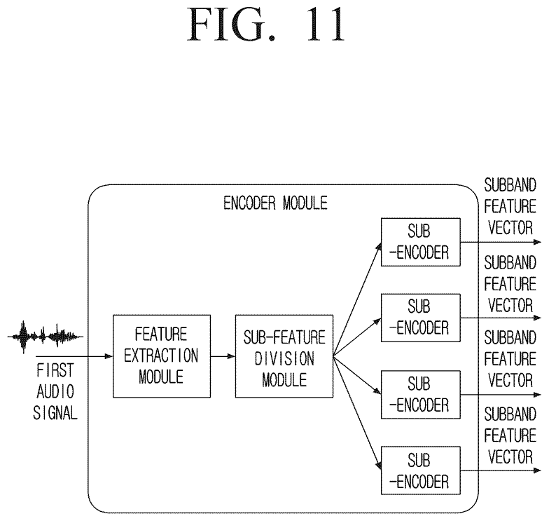

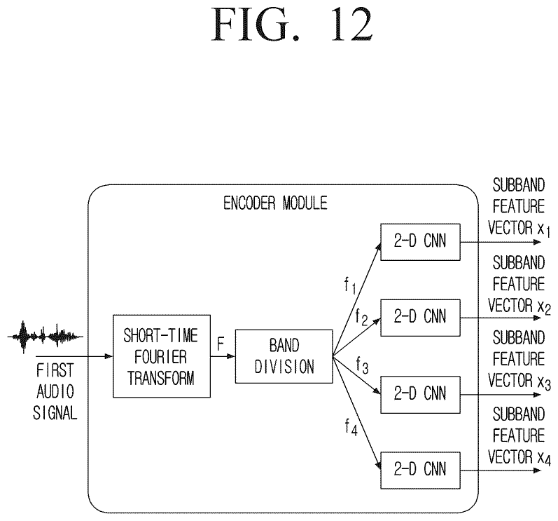

In the above descriptions, it is mentioned that the global information analysis module obtains the encoded features of the first audio signal from the encoder module, and accordingly, the method illustrated in FIG. 4A may actually further include obtaining the encoded features corresponding to the input first audio signal, and the step may include: extracting feature vectors from the first audio signal, obtaining the encoded features of the first audio signal by performing feature encoding on the extracted feature vectors. The process of obtaining the encoded features by encoding the first audio signal via the encoder module is described below with reference to FIGS. 11 and 12.

FIG. 11 is a block diagram illustrating an encoder module according to an embodiment of the disclosure. FIG. 12 is a network flowchart illustrating an encoder module according to an embodiment of the disclosure. The encoder module obtains high-dimensional feature vectors by encoding the input first audio signal. Referring to FIG. 11, the encoder module may include a feature extraction module, a sub-feature division module, and a plurality of sub-encoders.

Referring to FIG. 11, the feature extraction module performs feature extraction on the input first audio signal, to obtain a feature vector in another dimension. For example, a short-time Fourier transform (STFT) (e.g., a 512-point STFT) may be adopted to perform the feature extraction, i.e., framing and windowing as well as STFT are performed on the first audio signal to obtain features in a frequency domain.

For example, for a first audio signal of n seconds duration with a sampling rate of 16 k, there is L=n* 16000 sample-point data, and by performing STFT with a window length of W=s_n sample points (i.e., a number of sample points of each audio frame is s_n, and the overlapping area between audio frames is s_n/2 (i.e., overlapping 50%), i.e., a frame shift is W/2), the number k of frames is k=L/(s_n/2)−1, and a number of frequency points of each audio frame is f=s_n/2, from which real and imaginary parts of the frequency domain are extracted respectively, and thus a feature vector in a dimension of [k, f] may be obtained. For example, for a first audio signal of a time length of 4 s with a sampling rate of 16 k, after STFT with a window length of W=512 sample points (i.e., the frame shift is 256 sample points) is performed, the number of frames is 249, and the number f of frequency points of each audio frame is s_n/2=512/2=256, and each frequency point is represented with one real part and one imaginary part, thus, a feature vector in a dimension of [249, 256] may be obtained.

In the above example, STFT is used to perform the feature extraction, but the disclosure is not limited to this, and other feature extraction methods may be used, for example, the feature extraction is performed using a network of a convolutional neural network (CNN).

As illustrated in FIG. 12, the sub-feature division module performs frequency band division to divide a feature vector F extracted by the sub-feature division module, into a plurality of first sub-band feature vectors. For example, a frequency band of 16 k is divided into N subbands, and considering a performance and a model complexity, in one example, N may be equal to 4, 5, or 6, however, the disclosure is not limited to this. For example, as illustrated in FIG. 12, a frequency band of 16 k may be divided into 4 subbands, and for the frequency domain data obtained in the previous step, the data (i.e., the extracted feature vector) of the 256 frequency points of each audio frame may be divided into 4 first subband feature vectors f₁, f₂, f₃, and f₄, frequency points contained in the respective first subband feature vector are {1˜32}, {33˜64}, {65˜128}, and {129˜256}, respectively, and corresponding frequencies are 0˜2 k, 2 k˜4 k, 4 k-8 k, and 8 k-16 k, respectively.

Referring to FIG. 12, after the extracted feature vector F is divided into the plurality of first subband feature vectors, a plurality of second subband feature vectors are obtained by encoding each of the plurality of first subband feature vectors using corresponding subband encoders, wherein the encoded features of the first audio signal include the plurality of second subband feature vectors. Referring to FIGS. 11 and 12, the number N of the divided first subband feature vectors is 4, and accordingly, there are N=4 sub-encoders, and each of the first subband feature vectors is inputted into one corresponding sub-encoder (e.g., 2-dimensional convolutional neural networks (2D-CNN)) for encoding to obtain 4 second subband feature vectors, x₁, x₂, x₃, and x₄, wherein these obtained plurality of second subband feature vectors may be collectively referred to as the encoded features of the first audio signal. By dividing the extracted feature vector into the plurality of first subband feature vectors and encoding the corresponding first subband feature vectors using different sub-encoders, the disclosure may realize parallel encoding, reduce a model complexity and improve a processing speed of the model.

However, the disclosure is not limited thereto, and in another embodiment of the disclosure, the encoded features of the first audio signal may be obtained by encoding the extracted feature vector directly using a encoder module without frequency band division, that is, the full-band feature is encoded with only one encoder to obtain an encoded feature in a higher dimension. In the following descriptions, all referred vectors or encoded features of the sound refer to a vector or an encoded feature of one certain subband.

Returning to reference to FIGS. 10A and 10B, the global information analysis module performs the feature processing on the target dual-modal mask for each audio frame and the encoded features of the first audio signal based on the following two principles, to make the visual information and the sound information of the target consistent: (1) when there is no sound-related feature in the target dual-modal mask M_{dual} (wherein, “sound-related feature” is not a feature obtained by directly encoding a sound signal, but for example, direction information, motion information, or the like, of the sound), the global information analysis module may know that sound components of the current audio frame are all sound of the non-targets (i.e., none of them is the sound of the target), and thus, these non-targets may be labeled as interference sources, (2) when there is the sound-related feature in the target dual-modal mask M_{dual}, considering that a position of the interference sound source may overlap with that of the target, it can be marked that a sound component in the current audio frame may be the sound of the target.

After each audio frame of the first audio signal is processed by the global information analysis module, information of the global motion trend feature P_{global} of the target may be accumulated. The global motion trend feature P_{global} obtained after all audio frames of the first audio signal are processed may represent a smoother motion trajectory (or motion trend) of the target compared to the previous audio frames. In addition, in the disclosure, a feature scale of the global motion trend feature P_{global} does not change over time, and does not increase as information increases, that is, the motion information of the target is continuously compressed into one feature space.

Furthermore, when the global information analysis module processes each audio frame of the first audio signal, the information of the global sound feature S_{global} of the target changes (i.e., is constantly updated). Due to overlapping of position of the interference sound source with that of the target, sound generated by the interference sound source may be incorrectly labeled as the sound of the target at a previous moment (e.g., the previous audio frame) in the target vision mask (i.e., the sound feature of the interference sound source overlapping with the target is incorrectly added to the global sound feature S_{global} of the target updated after the previous audio frame is processed). But, through the processing one audio frame-by-one audio frame, when the target or the interference sound source moves and separates, the global information analysis module enables correction of the target and thus obtains the correct sound feature.

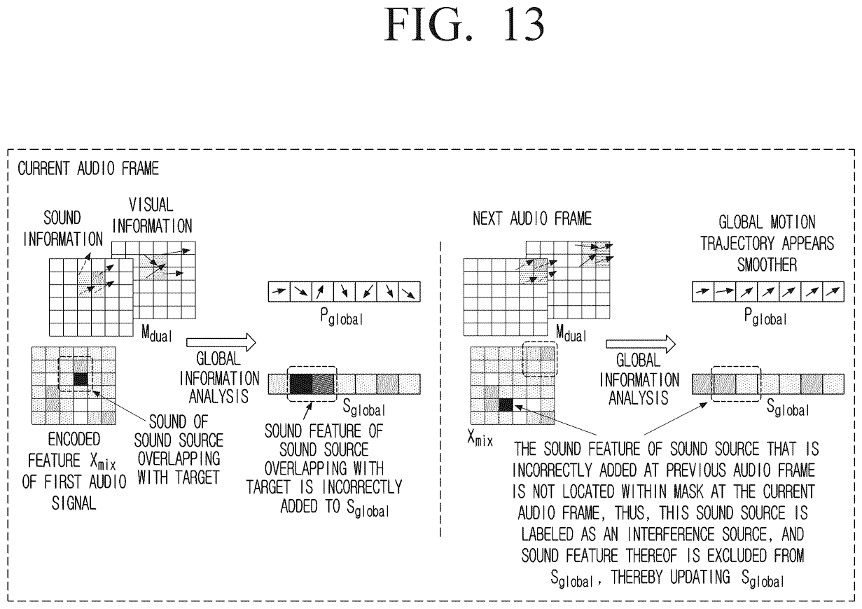

FIG. 13 shows a schematic diagram illustrating a process for performing a feature processing on a target dual-modal mask and encoded features of a first audio signal by a global information analysis module according to an embodiment of the disclosure.

Referring to FIG. 13, for the current audio frame, the global information analysis module, after performing a global information analysis based on the target dual-modal mask (specifically, the spatial motion trend based on the visual information) for the current audio frame and the encoded feature of the current audio frame, may obtain the global sound feature S_{global} of the target updated until the current audio frame (i.e., updated using the current audio frame) and the global motion trend feature P_{global} of the target accumulated (updated) until the current audio frame. As may be seen in FIG. 13, a global motion trajectory represented by the global motion trend feature P_{global} of the target accumulated (updated) until the current audio frame appears not very smooth, and the sound feature of the interference sound source overlapping with the target is incorrectly added to the global sound feature S_{global} of the target updated until the current audio frame. However, when at a next audio frame, the target or the interference sound source moves and separates, and thus, for the next audio frame, the global information analysis module, after performing the global information analysis based on the target dual-modal mask of this next audio frame and an encoded feature of this next audio frame, may obtain the global sound feature S_{global} of the target updated until this next audio frame and the global motion trend feature P_{global} of the target accumulated (updated) until this next audio frame. As may be seen in FIG. 13, a global motion trajectory represented by the global motion trend feature P_{global} of the target accumulated until this next audio frame appears smoother, and the sound feature of the sound source, that was incorrectly added to the global sound feature S_{global} at the previous audio frame of this next audio frame, is not present in the mask at this next audio frame. Thus, this sound source is labeled as the interference sound source, and the sound feature of this interference sound source is excluded from the global sound feature S_{global} of the target updated until this next audio frame.

Returning to refer to FIG. 10A, at operation S1020, the target sound mask of the target at each audio frame is determined based on the global sound feature and the global motion trend feature.

Specifically, operation S1020 may include: updating the target dual-modal mask for each audio frame, based on the global motion trend feature.

In an embodiment of the disclosure, operation S1020 may be performed by the mask update module. Referring to FIG. 10B, the mask update module may obtain the global motion trend feature P_{global} corresponding to the first audio signal from the global information analysis module, and obtain the target dual-modal mask M_{dual} of each audio frame in the first audio signal from the auditory-visual feature analysis module, and then update the target dual-modal mask M_{dual} of each audio frame, one audio frame-by-one audio frame, based on the global motion trend feature P_{global} corresponding to the first audio signal, there by obtaining the updated target dual-modal mask \tilde{M}_{dual} of each audio frame. The updated target dual-modal \tilde{M}_{dual} mask may represent more accurate spatial position and motion trend of the target as well as the sound feature.

Specifically, due to sound interference, a target motion direction obtained based on the sound characteristic may have a bias, meanwhile, an optical flow feature of each pixel estimated visually may have a bias, resulting in that a motion direction of the target at each frame may shake and a motion trend of the target characterized by the same will be less accurate. To this end, the mask update module updates the target dual-modal mask one audio frame-by-one audio frame based on the global motion trend feature. In one embodiment of the disclosure, the updating the target dual-modal mask for each audio frame, based on the global motion trend feature may include: adjusting at least one of the spatial motion trend and the sound source motion trend in the target dual-modal mask of the current audio frame, by comparing and performing trend consistency calculation on a motion trend of the target at the current audio frame and the global motion trend feature.

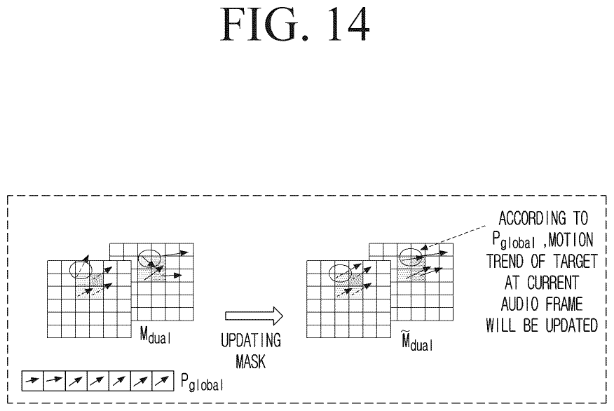

FIG. 14 is a diagram illustrating obtaining an updated target dual-modal mask according to an embodiment of the disclosure.

Referring to FIG. 14, the mask update module may, by performing feature processing on the motion trend of the current audio frame and the global motion trend feature P_{global} to implement the comparison and the trend consistency calculation between them, so as to fine-tune at least one of the spatial motion trend and the sound source motion trend in the target dual-modal mask M_{dual} at the current audio frame, thereby obtaining the updated target dual-modal mask \tilde{M}_{dual}. However, the disclosure is not limited thereto. In another embodiment of the disclosure, the mask update module may realize the comparison and the trend consistency calculation between the motion trend of the current audio frame and the global motion trend feature P_{global} by utilizing formula calculation, so as to realize fine-tuning of at least one of the spatial motion trend and the sound source motion trend in the target dual-modal mask M_{dual} at the current audio frame, and thus obtain the updated target dual-modal mask \tilde{M}_{dual}. The updated target dual-modal mask \tilde{M}_{dual} may more accurately represent the spatial information of the target.

Furthermore, operation S1020 may further include: determining the target sound mask of the target at each audio frame, based on the encoded features of the first audio signal, the global sound feature, and the updated target dual-modal mask for each audio frame.

Specifically, the operation of determining the target sound mask of the target at each audio frame, based on the encoded features of the first audio signal, the global sound feature, and the updated target dual-modal mask for each audio frame may be performed by the audio mask estimation module in FIG. 10B. According to obtaining the updated target dual-modal mask \tilde{M}_{dual} for each audio frame from the mask update module, the audio mask estimation module may know the accurate spatial information of the target, and meanwhile, according to the global sound feature of the target obtained from the global information analysis module, the audio mask estimation module may know a characteristic, a category, and the like of the sound of the target. Therefore, in determining the target sound mask of the target at each audio frame, the audio mask estimation module may eliminate a sound feature of the non-target from the encoded feature of each audio frame of the first audio signal based on the global sound feature S_{global} of the target and the updated target dual-modal mask \tilde{M}_{dual} for each audio frame, and determine (or estimate) the target sound mask for the target at each audio frame based on the encoded feature of each audio frame after the sound feature of the non-target is eliminated.

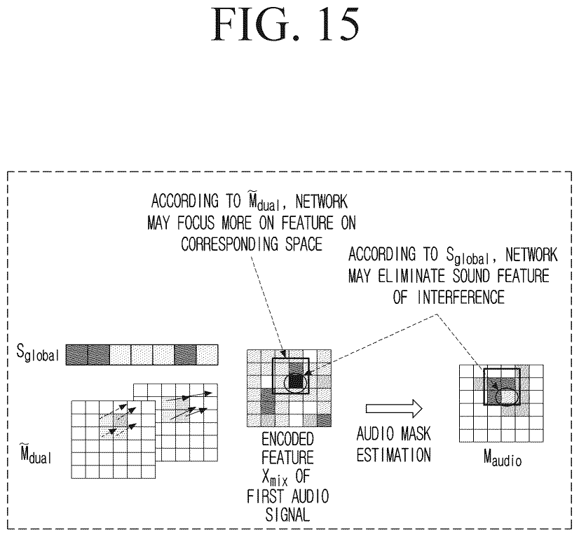

FIG. 15 is a diagram illustrating obtaining a target sound mask of a target at a current audio frame according to an embodiment of the disclosure.

Referring to FIG. 15, for the current audio frame, the audio mask estimation module may focus more on the feature on the corresponding space corresponding to the mask according to the updated target dual-modal mask \tilde{M}_{dual} for the current audio frame, and eliminate the sound feature of the interference sound source from the encoded feature of the current audio frame according to the global sound features S_{global} of the target, thereby obtaining the target sound mask M_{aduio} of the target at the current audio frame. In a similar manner, the audio mask estimation module may obtain the target sound mask of the target at each audio frame in the first audio signal.

In the above descriptions with reference to FIGS. 10A, 10B and 11 to 15, the dual-modal dual-stage sound extraction module firstly analyzes the global sound information (i.e., the target dual-modal mask M_{dual}) to obtain the global motion trajectory of the target, thereby correcting the motion trend of the target at each audio frame, and obtaining the accurate sound mask of the target, so as to avoid incorrectly extracting sound features of other interference sound sources.

In the disclosure, a recurrent neural network (RNN) may be used to implement the dual-modal dual-stage sound extraction module, but the disclosure is not limited to this, and another network (e.g., a CNN, an attention network, or the like) having a temporal processing capability may also be used to implement the dual-modal dual-stage sound extraction module.

Returning to reference to FIG. 4A, after the target sound masks of the target at the respective moments are obtained, at an operation S420, a second audio signal in which a sound related to the target is excluded is obtained based on the target sound masks of the target at the respective moments and the first audio signal. In the disclosure, the “sound related to the target” may be any sound generated by the target, for example, a sound made by a mouth, a sound generated due to a body movement (e.g., a walking sound, a clapping sound, a clothing rubbing sound, or the like), and the like.

Specifically, the obtaining a second audio signal based on a target sound mask of the target at respective moments and the first audio signal may include: removing, from the encoded features of the first audio signal, a feature of the sound related to the target based on the target sound mask of the target at each audio frame, to obtain non-target sound signal features of the first audio signal, obtaining the second audio signal based on the non-target sound signal features.

Referring to FIG. 4B, by performing the feature processing on the target sound mask of the target at each audio frame and the encoded features of the first audio signal, the feature of the sound related to the target may be removed from the encoded features of the first audio signal, thereby obtaining the non-target sound signal features of the first audio signal.

In one embodiment of the disclosure, after the non-target sound signal features of the first audio signal are obtained, feature decoding may be performed directly on the non-target sound signal features using a decoder, to obtain the second audio signal yₒₜₕₑᵣ. In other words, in this embodiment of the disclosure, an audio signal obtained after removing the sound related to the target from the first audio signal may be directly output as the second audio signal.

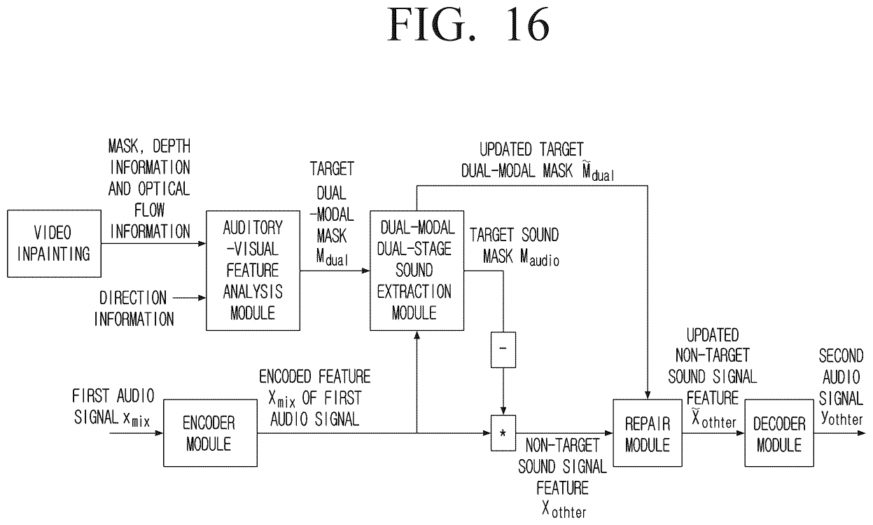

In another embodiment of the disclosure, the non-target sound signal features of the first audio signal are obtained, the updated non-target sound signal features may be obtained by repairing the non-target sound signal features of the first audio signal, and then, the second audio signal in which the sound of the non-target is enhanced or repaired may be obtained, by decoding the updated non-target sound signal features, thereby enhancing the user experience. Specifically, in an actual scenario, when the target blocks a sound of a certain sound source, after the target is removed, the sound of the sound source will not be blocked, and will be directly propagated to an electronic apparatus in a direction which was blocked by the target, and at this time, an intensity of a sound picked up by the electronic apparatus will become larger, and auditory perception of the user will be changed. Thus, for a video captured for the scenario where the sound of the certain sound source is blocked by the target, after the target is removed from the video, the better auditory perception may be provided to the user by enhancing or repairing the remaining sound of the non-target. Thus, in another embodiment of the disclosure, the step of obtaining a second audio signal based on the non-target sound signal feature may include repairing the non-target sound signal features based on the updated target dual-modal mask for each audio frame, to obtain the updated non-target sound signal features, obtaining the second audio signal by decoding the updated non-target sound signal features. This is described below with reference to FIG. 16.

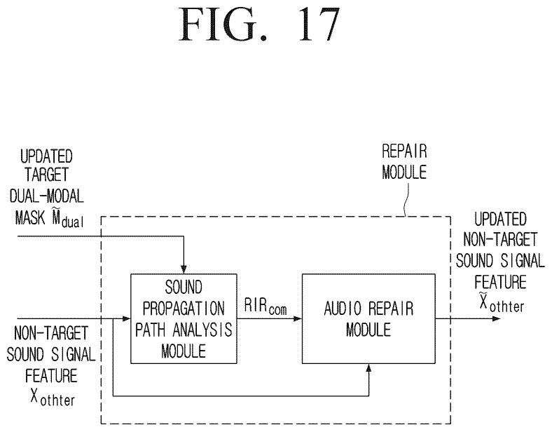

FIG. 16 illustrates a schematic diagram of a network structure corresponding to a method performed by an electronic apparatus according to an embodiment of the disclosure. FIG. 17 is a schematic diagram illustrating a structure of a repair module according to an embodiment of the disclosure. The other modules other than the repair module shown in FIG. 16 are the same as those illustrated in FIG. 4B, and therefore, they will not be described repeatedly here.

Referring to FIG. 16, the repair module may obtain the non-target sound signal feature Xₒₜₕₜₑᵣ of each audio frame of the first audio signal, and may obtain the updated target dual-modal mask \tilde{M}_{dual} for each audio frame from the dual-modal dual-stage sound extraction module, and then, perform feature processing on the non-target sound signal feature Xₒₜₕₜₑᵣ of each audio frame based on the updated target dual-modal mask \tilde{M}_{dual} for each audio frame, to obtain the updated non-target sound signal feature \tilde{X}ₒₜₕₜₑᵣ, and then, the decoder module decodes the updated non-target sound signal feature \tilde{X}ₒₜₕₜₑᵣ to obtain the second audio signal yₒₜₕₑᵣ. The process of obtaining the updated non-target sound signal feature \tilde{X}ₒₜₕₜₑᵣ is described below with reference to FIG. 17.

Referring to FIG. 17, a repair module may include a sound propagation path analysis module and an audio repair module, each of which may be implemented by a network capable of implementing feature processing, such as a convolutional network, an attention network, or a recursive network, and so on. Broadly speaking, the repair module performs a repair operation by utilizing a Room Impulse Response (RIR), wherein the RIR may include capturing and analyzing acoustic properties of one room or environment, for measuring and modeling a manner in which sound waves interact with a space (including a reflection, a reverberation, and an echo). However, when the sound source is obstructed by the target, the sound of the sound source in the video after the target is removed may be repaired by using a learned normal RIR_{com} (i.e., RIR_{com} of the sound source when being not obstructed by the target).

Specifically, the sound propagation path analysis module may obtain RIR_{com} of the non-target when being not obstructed by the target, based on the updated target dual-modal mask \tilde{M}_{dual} for each audio frame and the non-target sound signal feature Xₒₜₕₜₑᵣ.

In one embodiment of the disclosure, the obtaining the room impulse response of the non-target when being not obstructed by the target may include selecting, from the non-target sound signal features, signal features of a plurality of audio frames before and/or after the non-target is obstructed by the target, based on the updated target dual-modal mask for each audio frame, obtaining the RIR of the non-target when being not obstructed by the target, based on signal features corresponding to the plurality of audio frames. In the disclosure, in order to reduce impact of changes (e.g., movement) of other objects in the space on the sound to be repaired, when analyzing the RIR, only a plurality of audio frames adjacent to a moment when the non-target (i.e., the sound source other than the target) is obstructed by the target may be taken into account. For example, a first plurality of audio frames before being obstructed by the target and/or a second plurality of audio frames after being occluded by the target and subsequently not obstructed by the target may be selected based on the updated target dual-modal mask for each audio frame, to analyze the RIR, thereby obtaining the RIR when the sound source is not obstructed by the target. In the disclosure, according to an actual case, a suitable number of the first plurality of audio frames and/or the second plurality of audio frames may be selected based on the updated target dual-modal mask for each audio frame e.g., for a case where the non-target (i.e., another sound source or object) moves relatively slowly, the number of the first plurality of audio frames and/or the number of the second plurality of audio frames selected according to the updated target dual-modal mask for each audio frame may be larger, and then a more accurate RIR may be obtained, and for a case where the non-target (i.e., another sound source or object) moves more quickly, the number of the first plurality of audio frames and/or the number of the second plurality of audio frames selected according the updated target dual-modal mask for each audio frame may be smaller, to reduce the impact of these non-targets on the analysis of the RIR. By analyzing the signal features of these selected audio frames, the normal RIR_{com} of positions of these other sound sources or objects in the current environment may be obtained.

After RIR_{com} when the non-target is not obstructed by the target is obtained, the audio repair module may repair the non-target sound signal features based on the RIR_{com} obtained from the sound propagation path analysis module, to obtain the updated non-target sound signal features. Specifically, the audio repair module may perform feature processing on the non-target sound signal feature Xₒₜₕₜₑᵣ of each audio frame and RIR_{com}, thereby obtaining the updated non-target sound signal feature \tilde{X}ₒₜₕₜₑᵣ of each audio frame.

Furthermore, in another embodiment of the disclosure, after the target is removed from the video, a new object (e.g., a cat) may be added to the video from which the target has been removed, and accordingly, the audio repair module may utilize a similar method to add a sound of this object to the second audio signal based on a category of this object.

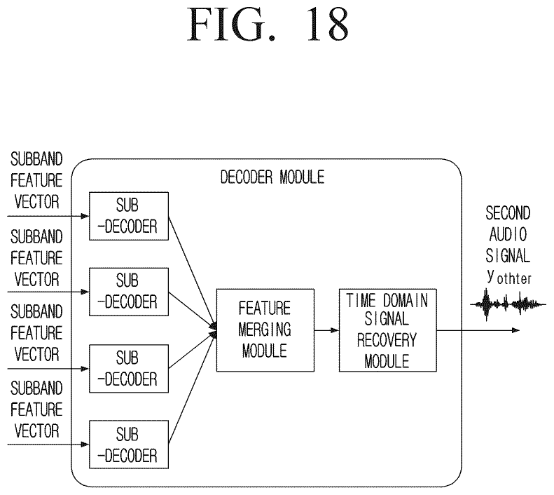

After the updated non-target sound signal feature \tilde{X}ₒₜₕₜₑᵣ is generated by the repair module, the decoder module may obtain the second audio signal, i.e., recover a time domain signal, by performing feature decoding on the updated non-target sound signal feature _{X}ₒₜₕₜₑᵣ of each audio frame feature. If the encoder module in FIG. 4A and FIG. 16 adopts the structure shown in FIG. 11, the decoder module may accordingly adopt a plurality of decoders to implement decoding, which is described below with reference to FIG. 18.

FIG. 18 is a block diagram illustrating a decoder module according to an embodiment of the disclosure.

Referring to FIG. 18, the decoder module includes a plurality of sub-decoders, a feature merging module, and a time domain signal recovery module. In the example illustrated in FIG. 18, the updated non-target sound signal features \tilde{X}ₒₜₕₜₑᵣ obtained from the repair module includes a plurality of subband features, and each sub-decoder performs feature processing on the corresponding subband feature. Then, the feature merging module merges the processed plurality of subband features, for subsequent feature transformation processing. Thereafter, the time domain signal recovery module may perform a sound signal recovery operation on the merged feature to obtain a processed sound signal, i.e., the second audio signal yₒₜₕₑᵣ. For example, the time domain signal recovery module may perform the sound signal recovery operation by using a short-time Fourier inverse transform, but the disclosure is not limited thereto, and the time domain signal recovery module may also perform the sound signal recovery operation by adopting other feature transformation methods, for example, using a CNN network to perform the sound signal recovery operation. In the disclosure, if the encoder module adopts the short-time Fourier transform to perform the feature extraction, then in the decoder module, the time domain signal recovery module may adopt the short-time Fourier inverse transform to perform the sound signal recovery operation, and correspondingly, if the encoder module adopts the CNN network to perform the feature extraction, then in the decoder module, the time domain signal recovery module may adopt the CNN network to perform the sound signal recovery operation.

The method of obtaining the second audio signal desired by the user by extracting and removing the sound of the target from the input first audio signal (i.e., the mixed audio signal) is described above with reference to the accompanying drawings, which may be applied to varieties of scenarios requiring the video inpainting, such that the sound of the inpainted video may more desirably reflect a sound environment of the inpainted video, e.g., it may be applied to the video inpainting of a cellphone in which the sound of the target or a sound within an area is extracted, separated, or eliminated. The following describes, by way of example, two application scenarios of the method performed by the electronic apparatus described above in the disclosure, but the actual use scenarios are not limited to these two scenarios.

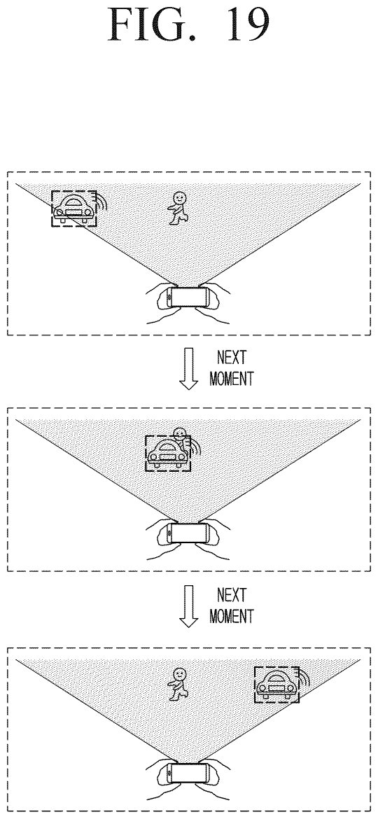

FIG. 19 illustrates a schematic diagram of applying a method performed by an electronic apparatus in a scenario where a target overlaps with other sound sources when a video is recorded according to an embodiment of the disclosure.

Referring to FIG. 19, when the video is being recorded, when a moving car (which is a target to be removed in the video inpainting, and whose area is labeled as a mask) overlaps with a position of a pedestrian at a certain moment, after the above method performed by the electronic apparatus of the disclosure is applied, only the sound of the car may be removed from the recorded video, meanwhile the sound of the pedestrian may be repaired accordingly.

Specifically, firstly, the user may record the video of the above scenario, and when the video inpainting operation is performed, the user may select the above car as the target to be removed, the sound of the car may be removed and the sound of the pedestrian may be retained by using the above method performed by the electronic apparatus of the disclosure. In addition, when the pedestrian in the video is obstructed by the car, the sound of the pedestrian will be processed and repaired accordingly, thereby improving listening experience of the user.

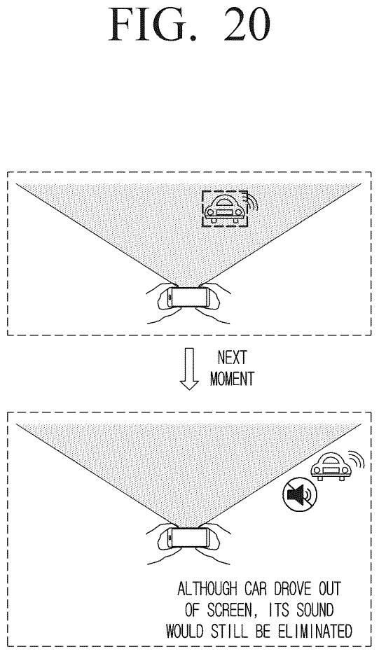

FIG. 20 illustrates a schematic diagram of applying a method performed by an electronic apparatus in a scenario where a target is not within a screen when a video is recorded according to an embodiment of the disclosure.

Referring to FIG. 20, when the video is being recorded, when a moving car (which is a target to be removed in the video inpainting, and whose area is labeled as a mask) drives out of the screen, the sound of the car may still be removed from the recorded video after the above method performed by the electronic apparatus of the disclosure is applied.

Specifically, firstly, the user may make a video recording of the above scenario, and when the video inpainting operation is performed, the user may select the above car as the target to be removed, and the sound of the car may be removed from the entire video by using the above method performed by the electronic apparatus of the disclosure, even if the car driven out of the screen, thereby improving listening experience of the user.

The above method performed by the electronic apparatus proposed in the disclosure may determine the sound of the target removed in the video inpainting based on the spatial position (e.g., the target vision mask), the movement direction, the movement speed, and the sound information of the target, and extract or eliminate the sound of the target. Furthermore, considering the original spatial impact of the target on other sound sources after the removal of the target in the video, the above method performed by the electronic apparatus may also repair the sound of the other sound sources. Further, considering that other things are filled after the removal of the target, the above method performed by the electronic apparatus may add the sound of this type of thing to the sound of the video. The above method proposed in the disclosure may be applicable not only to audio repair, but also to speech enhancement and speech analysis.

In embodiments of the disclosure, there is also provided an electronic apparatus that includes at least one processor, and alternatively, further includes at least one transceiver and/or at least one memory coupled to the at least one processor, wherein, the at least one processor is configured to perform the steps of the method provided in any alternative embodiment of the disclosure.

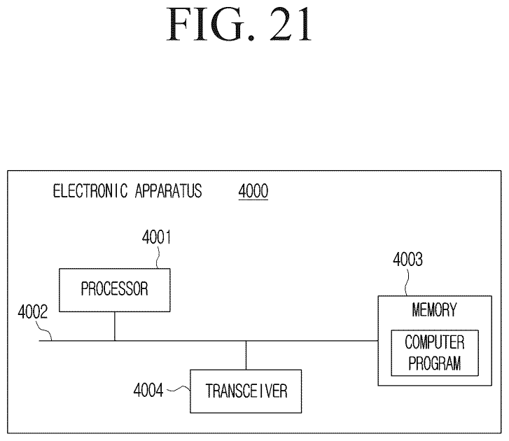

FIG. 21 illustrates a schematic diagram of a structure of an electronic apparatus applicable to an embodiment of the disclosure.

Referring to FIG. 21, the electronic apparatus 4000 shown in FIG. 21 includes a processor 4001 and memory 4003. Wherein the processor 4001 and the memory 4003 are coupled, e.g., through a bus 4002. Alternatively, the electronic apparatus 4000 may further include a transceiver 4004 which may be used for data interaction between the electronic apparatus and other electronic apparatuses, such as transmitting of data and/or receiving of data. It should be noted that, each of the processor 4001, the memory 4003, and the transceiver 4004 is not limited to one in a practice application, and the structure of the electronic apparatus 4000 does not constitute a limitation of the embodiments of the disclosure. Alternatively, the electronic apparatus may be the first network node, the second network node, or the third network node.

The processor 4001 may be a central processing unit (CPU), general purpose processor, digital signal processor (DSP), application specific integrated circuit (ASIC), field programmable gate array (FPGA) or other programmable logic device, transistor logic device, hardware part, or any combination thereof. It may implement or perform various logic boxes, modules, and circuits described in conjunction with the disclosed contents of the disclosure. The processor 4001 may also be a combination that implements computing functions, such as a combination containing one or more microprocessors, a combination of a DSP and a microprocessor, and the like.

The bus 4002 may include a pathway to transfer information between the above components. The bus 4002 may be a peripheral component interconnect (PCI) bus or an extended industry standard architecture (EISA) bus, and the like. The bus 4002 may be classed as an address bus, a data bus, a control bus, and the like. For ease of representation, only one bold line is shown in FIG. 21, but it does not mean that there is only one bus or one type of bus.

The memory 4003 may be read only memory (ROM) or other types of static storage apparatuses that can store static information and instructions, random access memory (RAM) or other types of dynamic storage apparatuses that can store information and instructions, may be electrically erasable programmable read only memory (EEPROM), compact disc read only memory (CD-ROM) or other optical disc storages, an optical disc storage (including compressed disc, laser disc, optical disc, digital universal disc, Blu-ray disc, or the like), a disk storage medium, other magnetic storage apparatuses, or any other medium that can be used to carry or store computer programs and can be read by a computer, it is not limited herein.

The memory 4003 is used to store computer programs or executable instructions for performing the embodiments of the disclosure, and is controlled for execution by the processor 4001. The processor 4001 is used to execute the computer programs or executable instructions stored in the memory 4003 to implement the steps shown in the preceding method of the embodiments.

An embodiment of the disclosure provides a computer readable storage medium storing computer programs or instructions, the computer programs or instructions, when being executed by at least one processor may perform or implement the steps in the preceding method of the embodiments and corresponding contents.

An embodiment of the disclosure provides a computer program product including computer programs, the computer programs, when being executed by a processor, may implement the steps shown in the preceding method of the embodiments and corresponding contents.

The terms “first”, “second”, “third”, “fourth”, “1”, “2” and the like (if exists) in the specification and claims of the disclosure and the above drawings are used to distinguish similar objects, and need not be used to describe a specific order or sequence. It should be understood that, data used as such may be interchanged in appropriate situations, so that the embodiments of the disclosure described here may be implemented in an order other than the illustration or text description.

It should be understood that, although each operation step is indicated by an arrow in the flowcharts of the embodiments of the disclosure, an implementation order of these steps is not limited to an order indicated by the arrows. Unless explicitly stated herein, in some implementation scenarios of the embodiments of the disclosure, the implementation steps in the flowcharts may be executed in other orders according to requirements. In addition, some or all of the steps in each flowchart may include a plurality of sub steps or stages, based on an actual implementation scenario. Some or all of these sub steps or stages may be executed at the same time, and each sub step or stage in these sub steps or stages may also be executed at different times. In scenarios with different execution times, an execution order of these sub steps or stages may be flexibly configured according to a requirement, which is not limited by the embodiment of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic apparatus, the method comprising:
obtaining target sound masks of a target in a first video at respective moments, based on image-related information of the target, a first audio signal corresponding to the first video, and direction information of the first audio signal; and
obtaining a second audio signal in which a sound related to the target is excluded, based on the target sound masks of the target at the respective moments and the first audio signal.

2. The method of claim 1, wherein the image-related information comprises:
a target vision mask;
depth information; and
optical flow information of the target.

3. The method of claim 1, wherein the obtaining of the target sound masks of the target in the first video at the respective moments, based on the image-related information of the target, the first audio signal corresponding to the first video, and the direction information of the first audio signal, comprises:
obtaining a first mask for each audio frame of the first audio signal, based on the image-related information and the direction information; and
obtaining the target sound mask of the target at each audio frame of the first audio signal, based on the first mask for each audio frame and encoded features of the first audio signal.

4. The method of claim 3, wherein the obtaining of the first mask for each audio frame of the first audio signal, based on the image-related information and the direction information, comprises:
obtaining a sound signal spatial distribution feature for each audio frame, by normalizing and encoding the direction information;
obtaining a target spatial distribution feature for each audio frame, by encoding a target vision mask and depth information of the target in the image-related information;
obtaining a first feature for each audio frame, based on the sound signal spatial distribution feature and the target spatial distribution feature; and
obtaining the first mask for each audio frame, based on the first feature and optical flow information of the target in the image-related information.

5. The method of claim 4,
wherein the obtaining of the first feature for each audio frame, based on the sound signal spatial distribution feature and the target spatial distribution feature, comprises:
obtaining the first feature for each audio frame, by performing a feature processing on the sound signal spatial distribution feature and the target spatial distribution feature, and
wherein the first feature represents a position of the target in a space, and a direction of a sound contained in the target vision mask.

6. The method of claim 4, wherein the obtaining of the first mask for each audio frame, based on the first feature and the optical flow information of the target in the image-related information, comprises:
determining a spatial motion trend of the target for each audio frame, based on the first feature and the optical flow information;
determining a sound source motion trend within the target vision mask for each audio frame, based on the first feature; and
obtaining the first mask for each audio frame, based on a determination result of the spatial motion trend and a determination result of the sound source motion trend.

7. The method of claim 6, wherein the determining of the spatial motion trend of the target for each audio frame, based on the first feature and the optical flow information, comprises:
determining the spatial motion trend based on visual information of the target at each sub-portion of a space for each audio frame, according to the first feature and a feature of the optical flow information.

8. The method of claim 6, wherein the determining of the sound source motion trend within the target vision mask for each audio frame, based on the first feature, comprises:
determining the sound source motion trend based on sound information of the target at each sub-portion of a space for each audio frame, according to the first feature.

9. The method of claim 3, wherein the obtaining of the target sound mask of the target at each audio frame of the first audio signal, based on the first mask for each audio frame and the encoded features of the first audio signal, comprises:
obtaining a global sound feature and a global motion trend feature of the target, based on the first mask for each audio frame and the encoded features of the first audio signal, wherein the global sound feature represents a feature of all sound related to the target, and wherein the global motion trend feature represents motion trajectory information of the target in the first video; and
determining the target sound mask of the target at each audio frame, based on the global sound feature and the global motion trend feature.

10. The method of claim 9, wherein the determining of the target sound mask of the target at each audio frame, based on the global sound feature and the global motion trend feature comprises:
updating the first mask for each audio frame, based on the global motion trend feature; and
determining the target sound mask of the target at each audio frame, based on the encoded features of the first audio signal, the global sound feature, and the updated first mask for each audio frame.

11. The method of claim 10, wherein the determining of the target sound mask for the target at each audio frame, based on the encoded features of the first audio signal, the global sound feature, and the updated first mask for each audio frame comprises:
eliminating a sound feature of a non-target from encoded feature of each audio frame of the first audio signal, based on the global sound feature and the updated first mask for each audio frame; and
determining the target sound mask of the target at each audio frame, based on the encoded feature of each audio frame after the sound feature of the non-target is eliminated.

12. The method of claim 3, wherein the obtaining of the second audio signal in which the sound related to the target is excluded, based on the target sound masks of the target at the respective moments and the first audio signal, comprises:
removing, from the encoded features of the first audio signal, a feature of the sound related to the target based on the target sound mask of the target at each audio frame, to obtain non-target sound signal features of the first audio signal; and
obtaining the second audio signal based on the non-target sound signal features.

13. The method of claim 12, wherein the obtaining of the second audio signal, based on the non-target sound signal features, comprises:
repairing the non-target sound signal features based on the updated first mask for each audio frame, to obtain the updated non-target sound signal features; and
obtaining the second audio signal by decoding the updated non-target sound signal features.

14. The method of claim 13, wherein the updated first mask is obtained by:
obtaining a global motion trend feature based on the first mask for each audio frame and the encoded features of the first audio signal; and
updating the first mask for each audio frame based on the global motion trend feature.

15. The method of claim 14, wherein the updating of the first mask for each audio frame based on the global motion trend feature comprises:
adjusting at least one of a spatial motion trend and a sound source motion trend in the first mask of a current audio frame, by comparing and performing trend consistency calculation on a motion trend of the target at the current audio frame and the global motion trend feature.

16. An electronic apparatus comprising:
memory, including one or more storage media, storing instructions; and
at least one processor communicatively coupled to the memory,
wherein the instructions, when executed by the at least one processor individually or collectively, cause the at least one processor to:
obtain target sound masks of a target in a first video at respective moments, based on image-related information of the target, a first audio signal corresponding to the first video, and direction information of the first audio signal, and
obtain a second audio signal in which a sound related to the target is excluded, based on the target sound masks of the target at the respective moments and the first audio signal.

17. The electronic apparatus of claim 16, wherein the image-related information comprises:
a target vision mask;
depth information; and
optical flow information of the target.

18. The electronic apparatus of claim 16, wherein the instructions, when executed by the at least one processor individually or collectively, further cause the electronic apparatus to:
obtain a first mask for each audio frame of the first audio signal, based on the image-related information and the direction information, and
obtain the target sound mask of the target at each audio frame of the first audio signal, based on the first mask for each audio frame and encoded features of the first audio signal.

19. One or more non-transitory computer-readable storage media storing one or more computer programs including computer-executable instructions that, when executed by one or more processors of an electronic apparatus individually or collectively, cause the electronic apparatus to perform operations, the operations comprising:
obtain target sound masks of a target in a first video at respective moments, based on image-related information of the target, a first audio signal corresponding to the first video, and direction information of the first audio signal, and
obtain a second audio signal in which a sound related to the target is excluded, based on the target sound masks of the target at the respective moments and the first audio signal.

20. The one or more non-transitory computer-readable storage media of claim 19, wherein the image-related information comprises:
a target vision mask;
depth information; and
optical flow information of the target.
